(19) United States
(12) Patent Application Publication
(10) Pub. No.: US 2020/0126302 A1
(43) Pub. Date: Apr. 23, 2020

(54) Augmented Reality Platform and Method

(71) Applicants: Anuj Sharma, New Delhi (IN); Priyanka Grover, New Delhi (IN)

(72) Inventors: Anuj Sharma, New Delhi (IN); Priyanka Grover, New Delhi (IN)

(21) Appl. No.: 16/279,357

(22) Filed: Feb. 19, 2019

(30) Foreign Application Priority Data
Oct. 20, 2018 (IN) 201811039691

(51) Int. Cl. G06T 19/00

(52) U.S. Cl. CPC G06T 19/006

(57) ABSTRACT

Described herein is a system for providing complete global mobility, operation and execution anytime, anywhere, anyplace and by any user; the system using Augmented Reality-Mixed Reality for creating live Hologram Projections (digital twins) of all available Physical Assets including assets such as humans in real world complete with monitoring, visualization, communication, operations and execution capabilities; the system incorporating Data Infused Holograms with Artificial Intelligence (Ai) Powered Descriptive, Predictive, Prescriptive and Cognitive (Fully Autonomous) Analytics and operative capabilities for Global Healthcare Ecosystems; each Hologram of the physical assets having infinite data points as required.

### CROSS-REFERENCE TO RELATED APPLICATION(S)

The present application claims priority to Indian Provisional Application 201811039691, entitled “The Zeus Project,” filed Oct. 20, 2018 in English, the entire contents of which are hereby incorporated by reference in their entirety.

### FIELD OF INVENTION

The present invention relates general to augmented and/or mixed reality platforms suitable for use with Healthcare, Pharma, Medical Emergency, Medical Waste, Medical manufacturing, Medical Robotics-UAV, Medical Facilities, Patient and medical Staff Command and Control, Operations and Planning.

### SUMMARY OF INVENTION

Disclosed embodiments of the present invention use Augmented Reality-Mixed Reality to create live “Digital Twins” referred to as Hologram Projections of all available “Physical Assets including humans in real world complete with monitoring, visualization, communication, operations and execution capabilities incorporating Artificial Intelligence (Ai) Powered Descriptive, Predictive, prescriptive and Cognitive (Fully autonomous) Analytics and operative capabilities for Global Healthcare ecosystems. In some embodiments, the following hardware can be used to implement the platform: HoloLens AR-MR Glasses, META 2 AR-MR Glasses, Any AR-MR Glasses, Magic Leap MR Glasses, Unity 3D, Vuforia, Maya 3D, Microsoft .Net Platform, Azure Cloud Platform, HTML 5, CSS 3, JavaScript, Angular, jQuery, IOT tech, AI/Machine Learning, Python.

The present summary is provided only by way of example, and not limitation. Other aspects of the present invention will be appreciated in view of the entirety of the present disclosure, including the entire text, claims and accompanying figures.

### BRIEF DESCRITPTION OF ACCOMPNAYING DRAWINGS

FIG. 1 is a view of a user wearing a wearable portion of a system, together with a hologram box, according to an embodiment of the present invention.

FIG. 2 to FIG. 32 illustrate example platform displays and interfaces and user interactions.

FIG. 33 is a schematic representation of a computer usable with embodiments of the present system.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION OF EMBODIMENTS

The Zeus Project can provide a single Global platform for Healthcare, Pharma, Medical Emergency, Medical Waste, Medical manufacturing, Medical Robotics-UAV, Medical Facilities, Patient and medical Staff Command and Control, Operations and Planning powered with Artificial Intelligence operational and analytics and real time monitoring through live “Digital Twins” referred to as Hologram Projections of all available “Physical Assets” including humans.

Embodiments of the present invention can provide:
I. Live Hologram projections “Digital Assets” of all on field “Physical Assets” including humans
II. Data Infused Holograms with Artificial Intelligence (Ai) Powered Descriptive, Predictive, prescriptive and Cognitive (Fully autonomous) Analytics and operative capabilities for Global Healthcare Ecosystems. Each Hologram of a Physical asset has infinite data points as required.
III. Zeus Project provides live holographic visualizations of all medical assets and every surface area of the earth; all seas, waterways, space and land.
IV. Live visualizations in holographic visualizations with Ai Analytics in real time leads to total awareness, planning, rehearsal, and execution-operations.
V. Zeus Project creates Absolute Situational awareness by providing real-time information on the current situation and execution-operational capabilities from Zeus Project itself. Zeus Project can be accessed anytime anywhere and provides complete mobility for entire operations. No Brick and Mortar facilities are required to operate Zeus Project.
VI. Zeus Project provides complete global mobility, operation and execution anytime, anywhere, anyplace and by any user authorized to access Zeus Project. All Function of Zeus Project are “Touch” and “Voice Command “Enabled.
VII. Zeus Project will be developed in AR (Augmented Reality-MR (Mixed Reality) Holographic screens and projections
VIII. Zeus Project will also be developed in software mode available in computers, tablets, mobile phones and smart screens
IX. Zeus Project should be operated on a secured -encrypted environment due to its sensitivity and strategic deployment capabilities.
X. Authority levels of Zeus Project access per screen and functions can be decided as per user requirements.
XI. Zeus Project Holograms can also be held by hand and moved around.

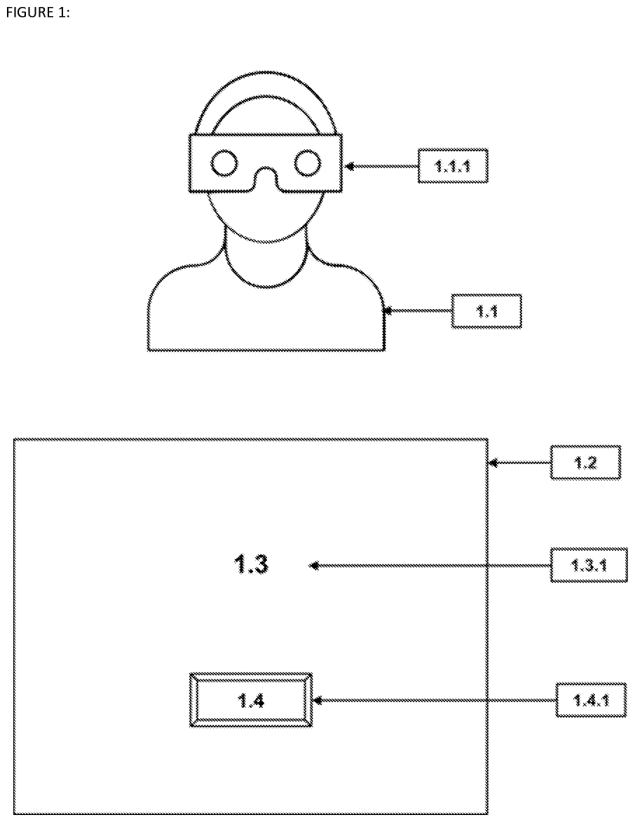

1. As shown in FIG. 1, to Start Zeus, 1.1 USER (HUMAN/ALIEN/ROBOT) can:
A. USER (HUMAN/ALIEN/ROBOT) Wear 1.1.1 SMART EYEWEAR with Augmented Reality (AR)—Mixed Reality (MR) holographic projection capability or
B. 1.1 USER (HUMAN/ALIEN/ROBOT) starts device with Augmented Reality (AR)—Mixed Reality (MR) holographic projection capability

2. Post Starting Zeus, 1.1 USER (HUMAN/ALIEN/ROBOT) sees 1.2 HOLOGRAM BOX IN AR-MR with 1.3.1 HOLOGRAM TEXT IN AR-MR. User can click 1.4 ENTER which is a 1.4.1 CLICKABLE BUTTON OR VOICE COMMAND ACTIVATED

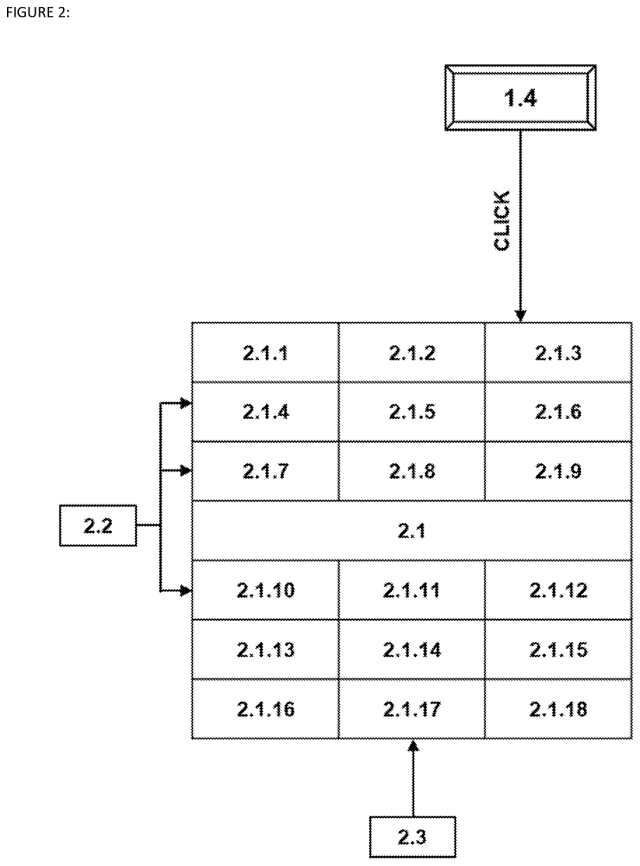

3. FIG. 2 depicts user clicking 1.4 ENTER to come to Zeus Central Command and Zeus Ai Command (2.1 ZEUS AI—ARTIFICIAL INTELLIGENCE). User can click on any box (2.2 EVERY BOX IS CLICKABLE IN EVERY ROW AND COLUMN). User can click on options of 2.1.1 PATIENT MANAGEMENT, 2.1.2 HOSPITAL MANAGEMENT, 2.1.3 PHARMACY MANAGEMENT, 2.1.4 AMBULANCE/EMERGENCY MANAGEMENT, 2.1.5 MEDICAL WASTE DISPOSAL MANAGEMENT, 2.1.6 MEDICAL MANUFACTURING MANAGEMENT, 2.1.7 MEDICAL DRONES MANAGEMENT, 2.1.8 MEDICAL DOCTORS AND NURSES MANAGEMENT, 2.1.9 MEDICAL ROBOTICS MANAGEMENT, 2.1.10 PATIENT AI, 2.1.11 HOSPITAL AI, 2.1.12 PHARMACY AI, 2.1.13 AMBULANCE/EMERGENCY AI, 2.1.14 MEDICAL WASTE DISPOSAL AI, 2.1.15 MEDICAL MANUFACTURING AI, 2.1.16 MEDICAL DRONES AI, 2.1.17 MEDICAL DOCTORS AND NURSES AI, 2.1.18 MEDICAL ROBOTICS AI

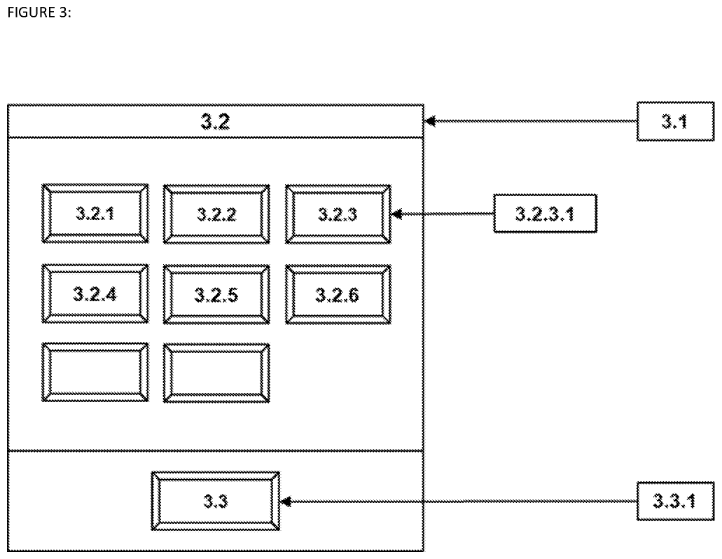

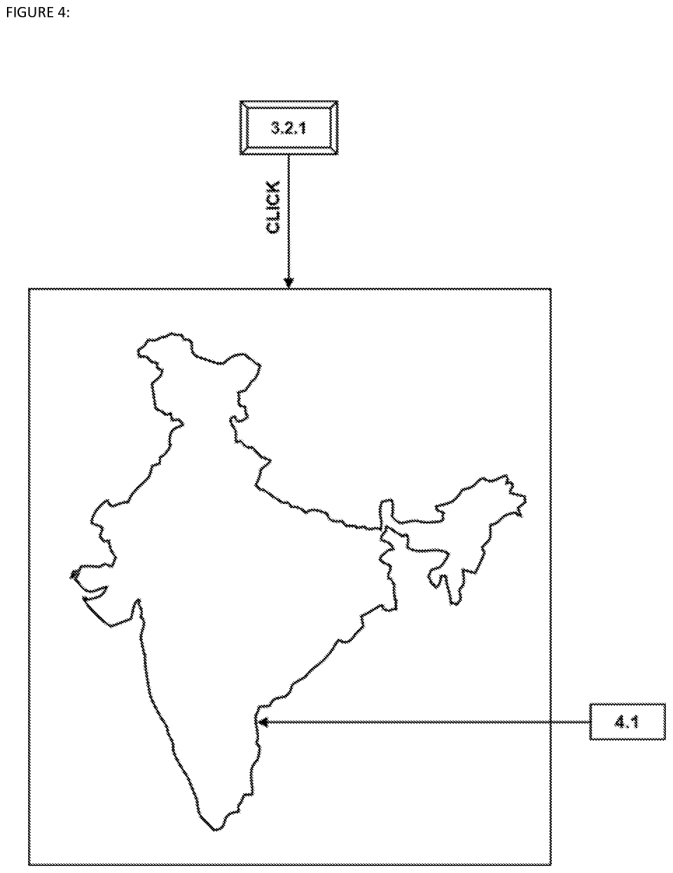

4. From FIG. 2, user selects any box, for example user selects “Hospitals” and 3.2 HOSPITAL COMMAND and 3.1 HOLOGRAM BOX IN AR-MR opens as shown in FIG. 3 with 3.2.3.1 CLICKABLE BUTTONS OF ALL COUNTRIES like 3.2.1 INDIA, 3.2.2 RUSSIA, 3.2.3 USA, 3.2.4 CHINA, 3.2.5 UK, 3.2.6 FRANCE. User can also click on 3.3 WORLD which is 3.3.1 CLICKABLE BUTTON TO COMBINE ALL COUNTRIES OF THE WORLD. TAKES YOU TO A 3-D EARTH HOLOGRAM.

5. When user click on any country in FIG. 3, FIG. 4 opens depicting for example 3.2.1 INDIA, a 4.1 HOLOGRAM MAP of the selected country opens up.

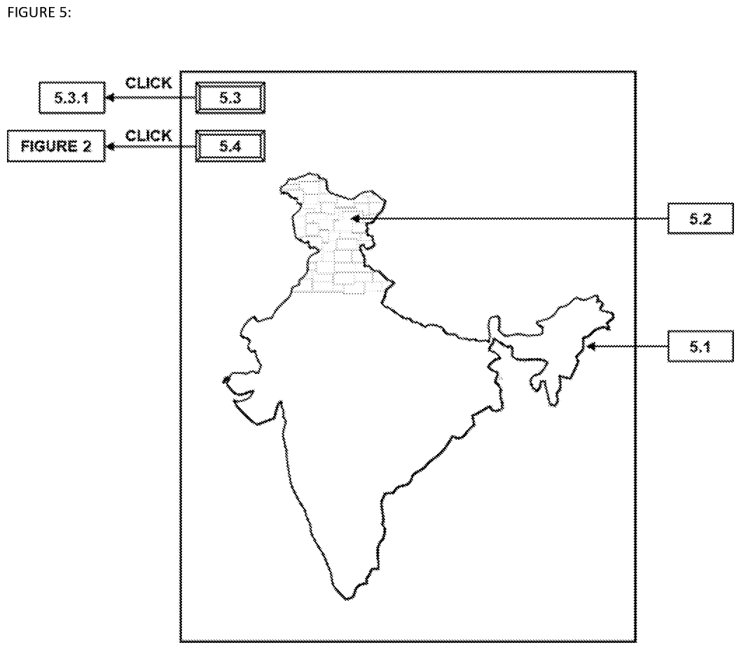

6. FIG. 5 is a detailed illustration of FIG. 4. The country opens as a 5.1 HOLOGRAM MAP with 5.2 ENTIRE COUNTRY IS DIVIDED INTO MICRO “GPS GRIDS”. User can also click on buttons like 5.3 BACK (5.3.1 CLICK) and 5.4 CENTRAL COMMAND (REFERS TO FIG. 2 OF THIS DOCUMENT)

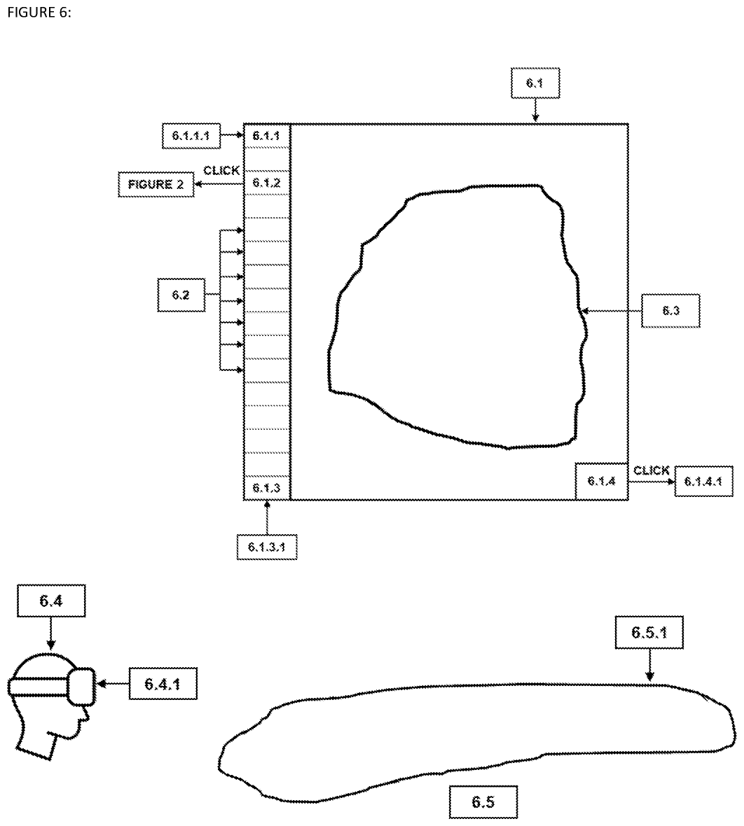

7. FIG. 6 depicts that 6.4 USER can click any 6.5.1 GRID to expand its hologram view (6.3 EXPANDED GRID) into a 3-D on ground or in Air projections like 6.1 HOLOGRAM BOX. User can click on buttons like 6.1.1 BACK (6.1.1.1 BUTTON TAKES YOU TO BACKSCREEN), 6.1.2 CENTRAL COMMAND (REFERS TO FIGURE TO OF THIS DOCUMENT), 6.1.3 ALL (6.1.3.1 BUTTON WHICH COMBINES ALL ASSETS). User can click on every asset linked to Zeus like 6.2 LIST OF ALL MEDICAL “ASSETS”. User can also click 6.1.4 SATELLITE IMAGE which leads to 6.1.4.1 CLICK ON THIS AND GRID WILL SHOW ITS SATELLITE IMAGE

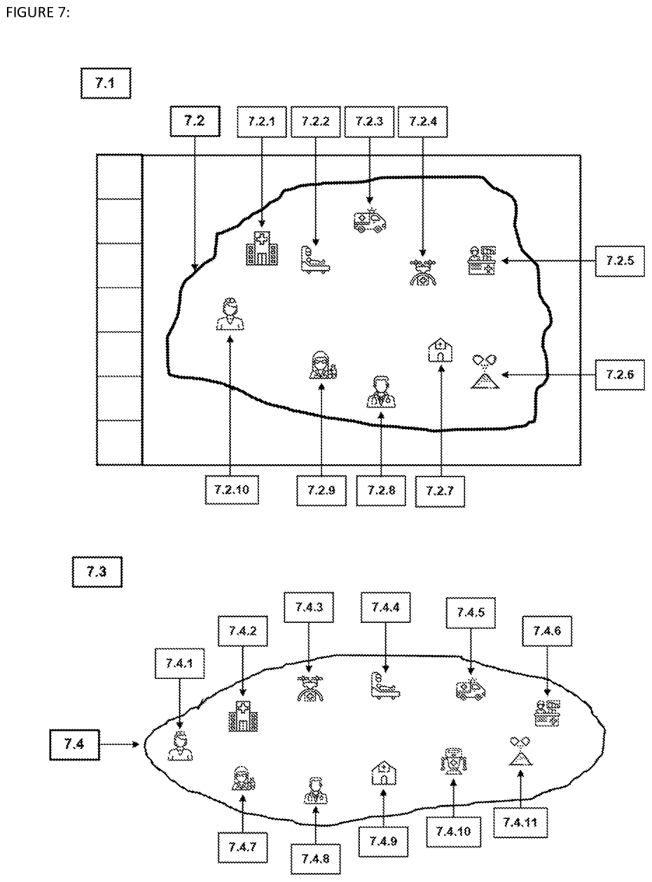

8. FIG. 7 depicts that User can click on any asset or all assets on the 7.1 AIR VIEW 7.2 GRID or 7.4 GRID, 7.3 GROUND VIEW. User can click assets like 7.2.1 HOSPITAL, 7.2.2 PATIENT, 7.2.3 AMBULANCE, 7.2.4 MEDICAL DRONE, 7.2.5 PHARMACY, 7.2.6 MEDICAL WASTE DEPOSIT UNIT, 7.2.7 CLINIC, 7.2.8 DOCTOR, 7.2.9 MEDICAL MANUFACTURER, 7.2.10 NURSE, 7.4.1 NURSE, 7.4.2 HOSPITAL, 7.4.3 MEDICAL DRONE, 7.4.4 PATIENT, 7.4.5 AMBULANCE, 7.4.6 PHARMACY, 7.4.7 MEDICAL MANUFACTURER, 7.4.8 DOCTOR, 7.4.9 CLINIC, 7.4.10 MEDICAL ROBOT, 7.4.11 MEDICAL WASTE DEPOSIT UNIT

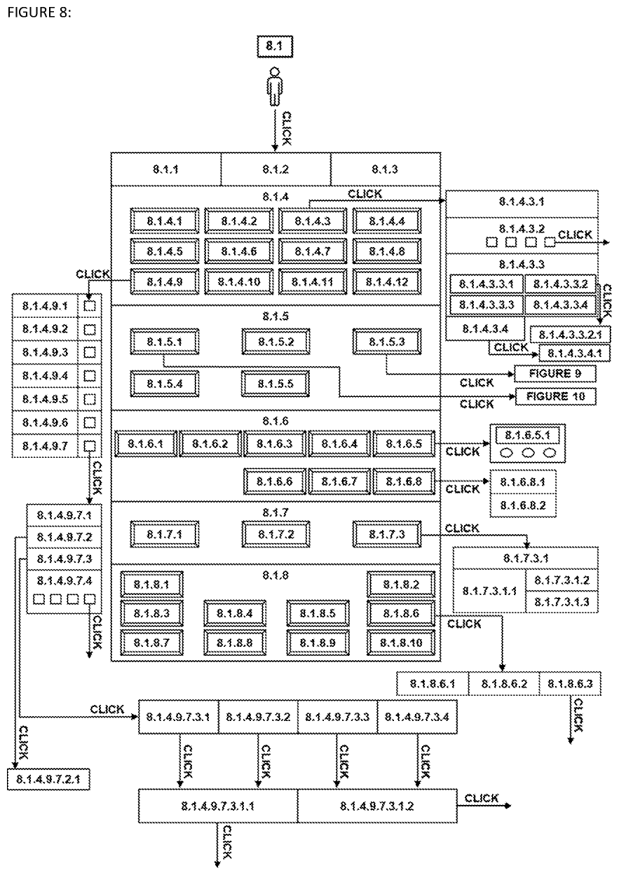

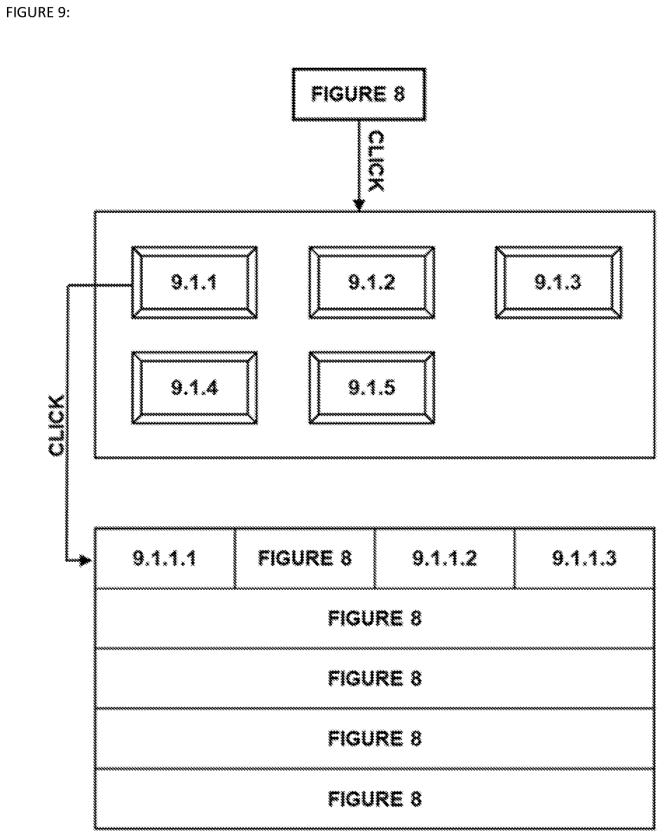

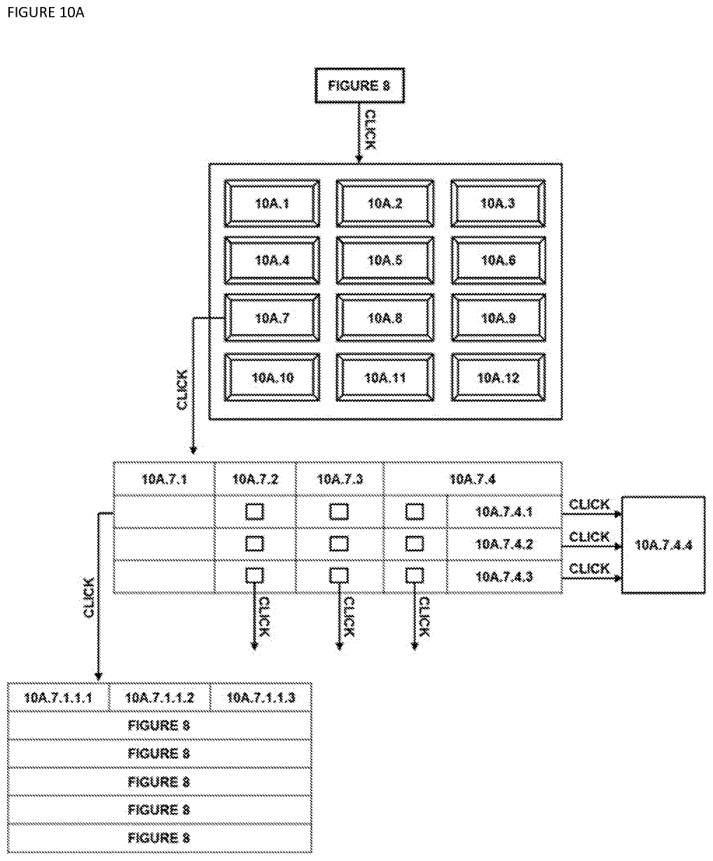

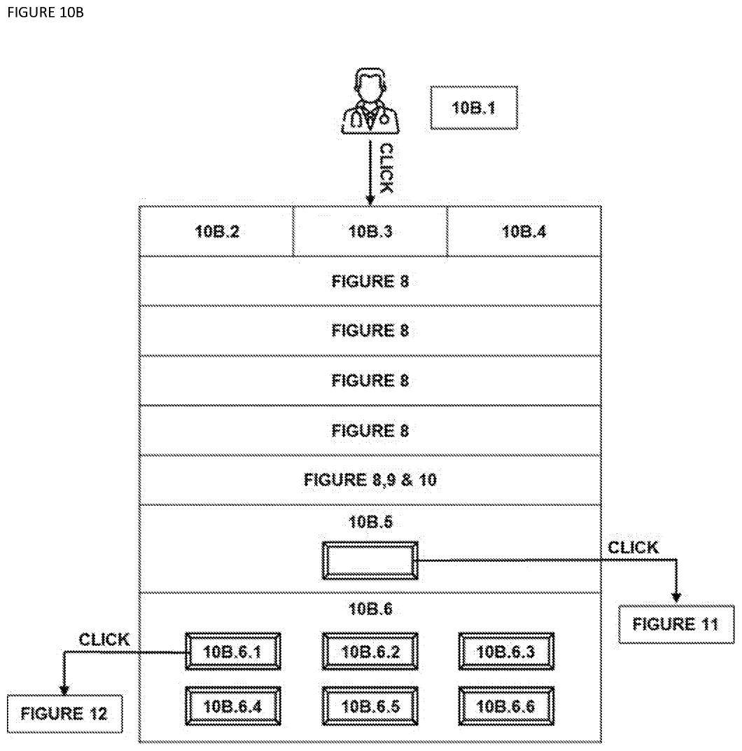

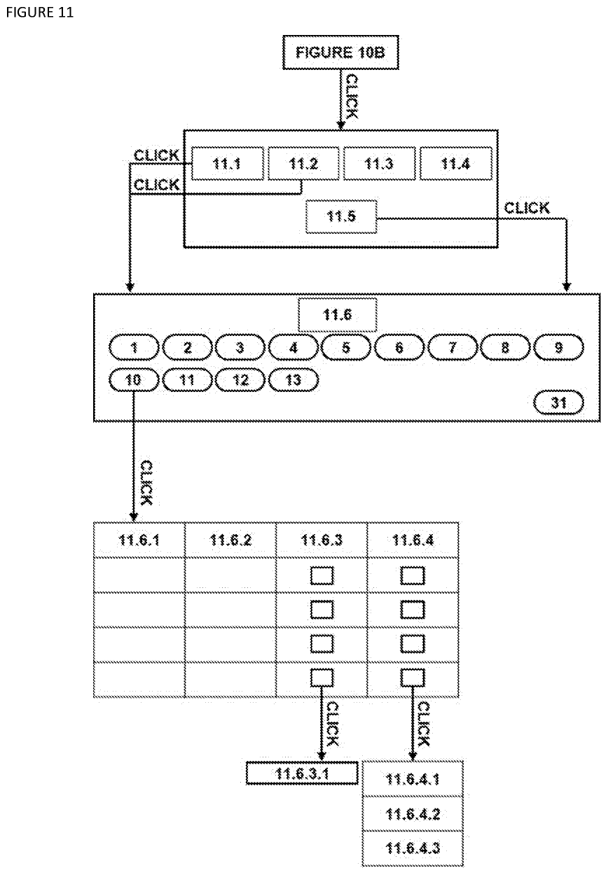

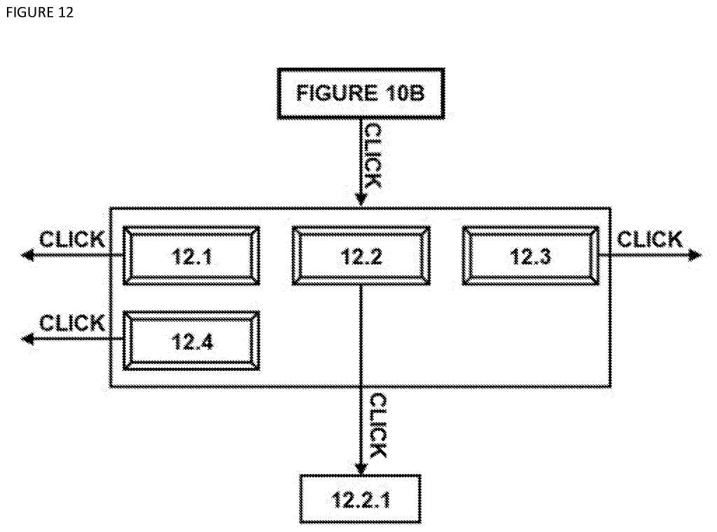

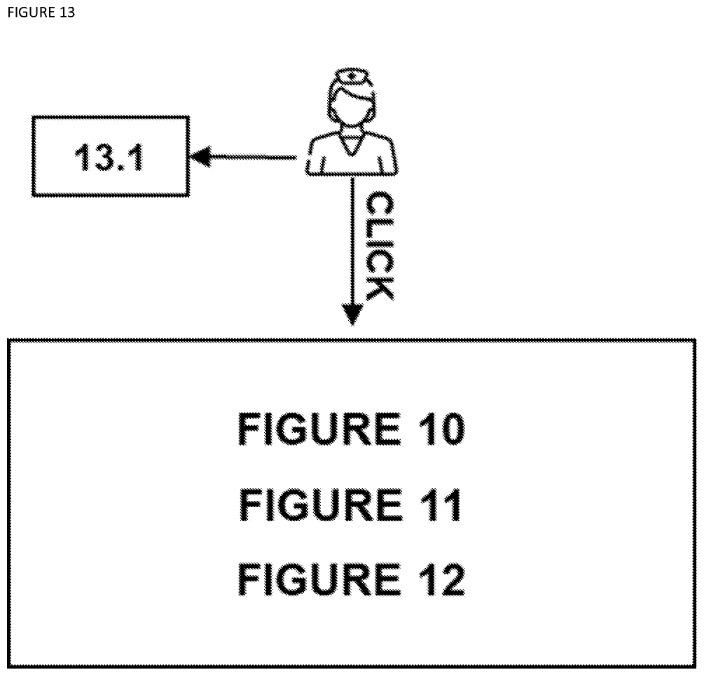

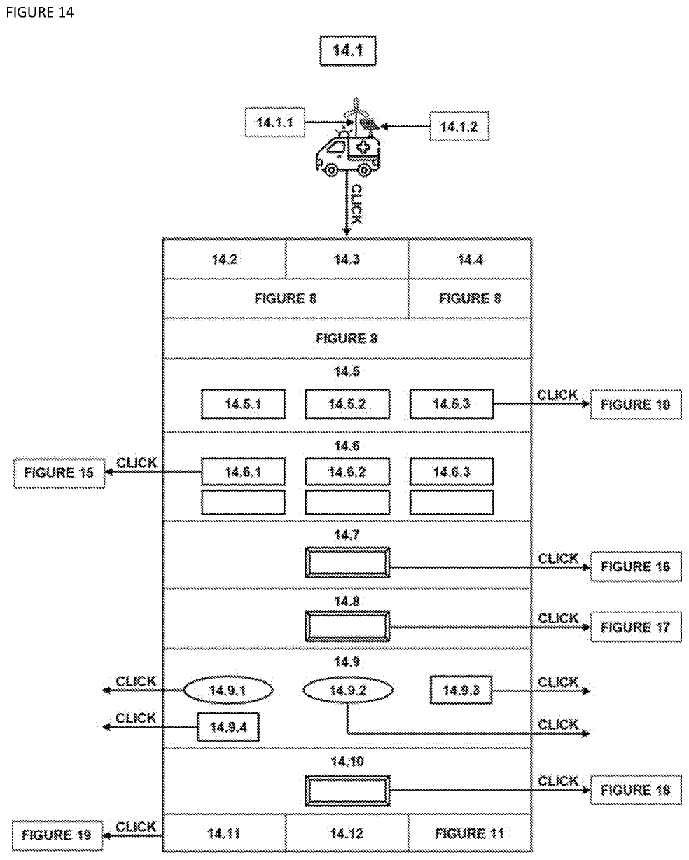

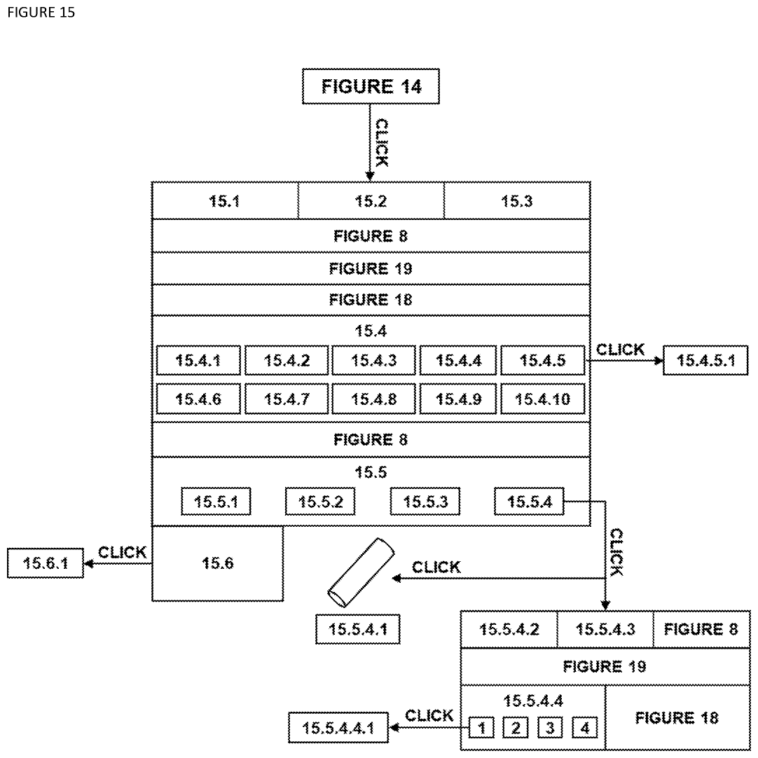

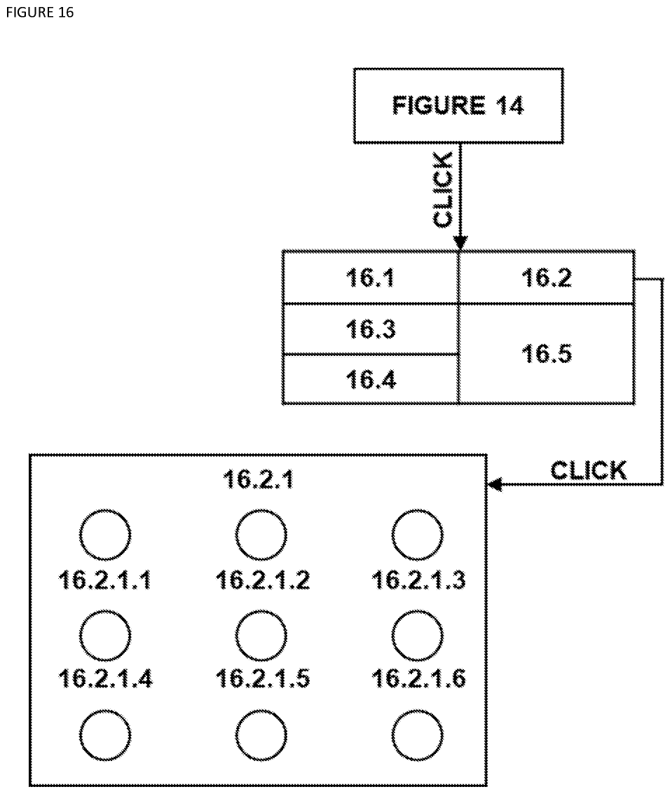

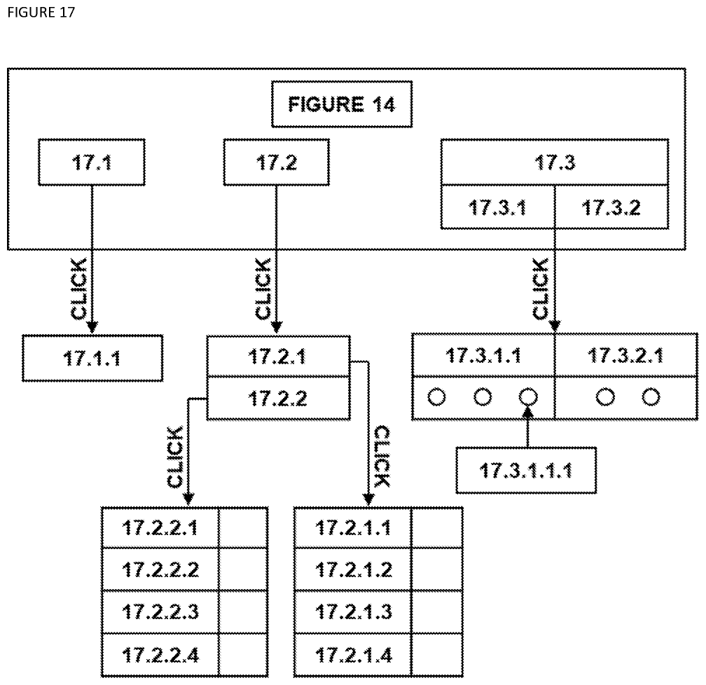

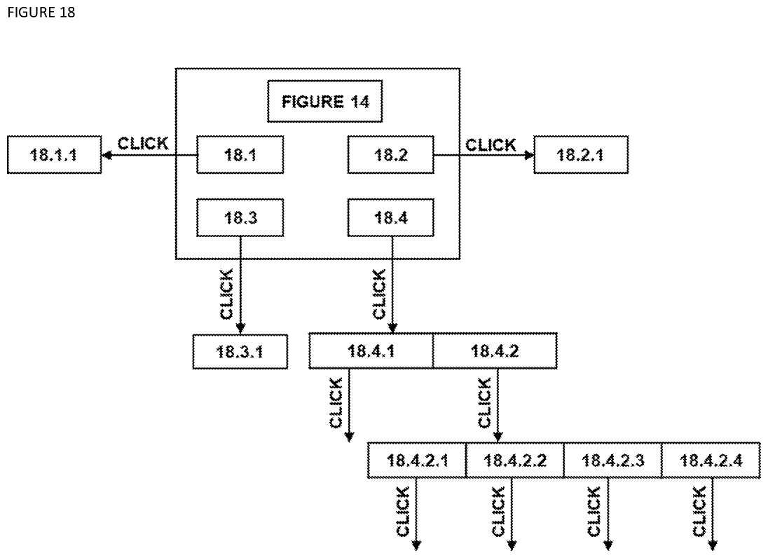

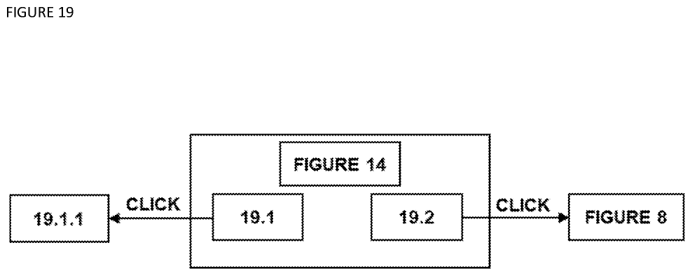

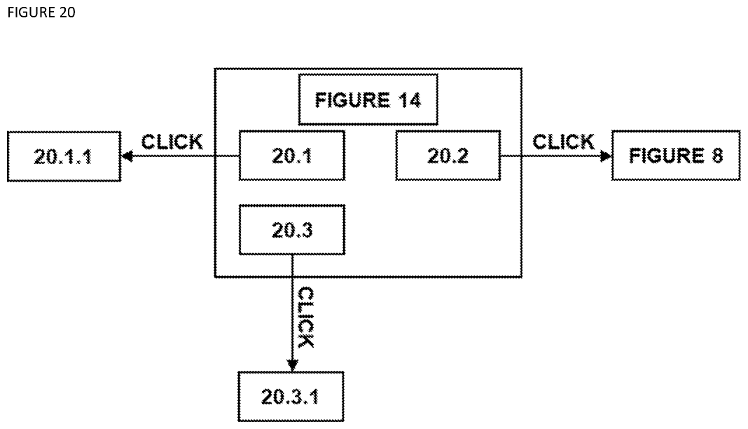

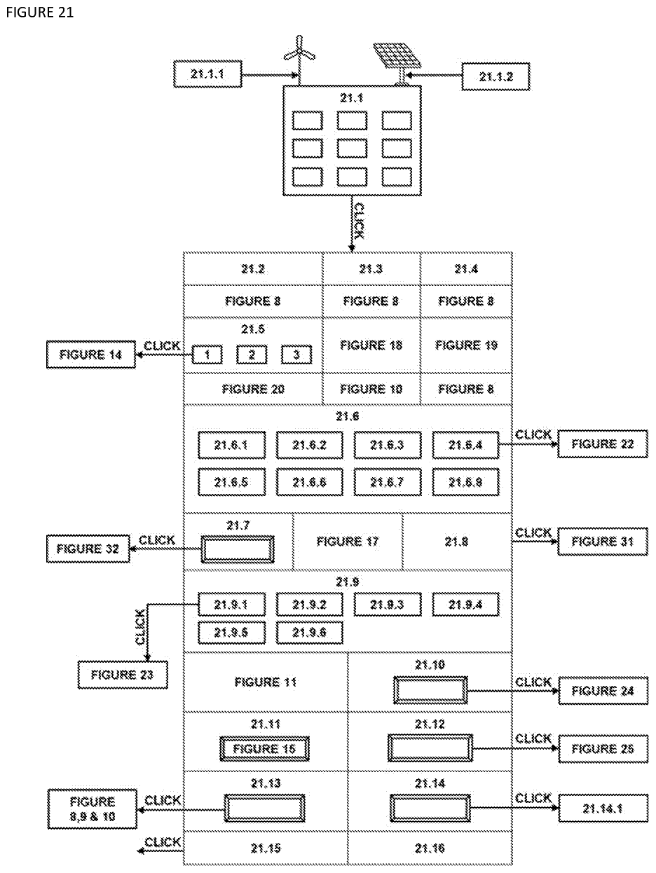

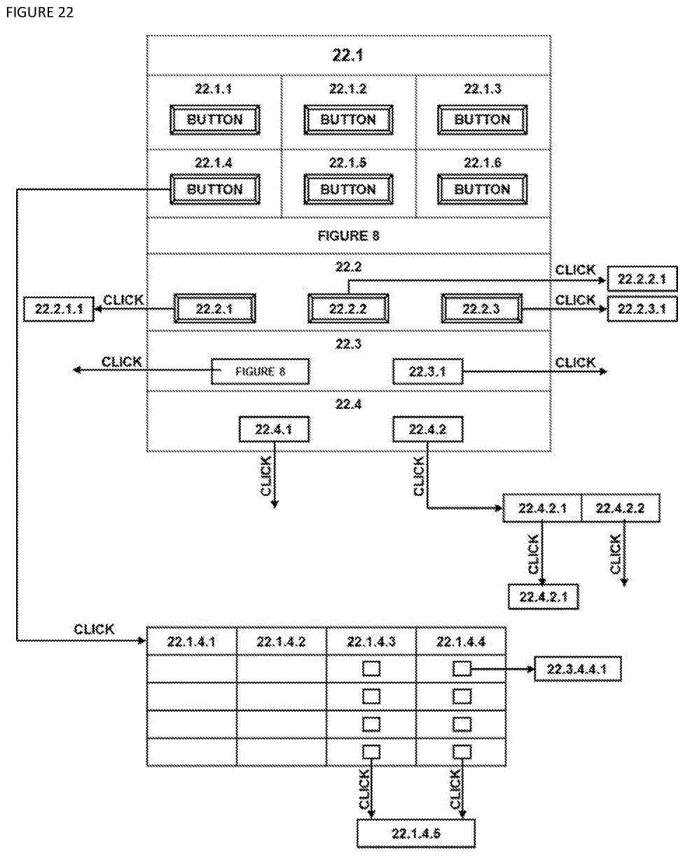

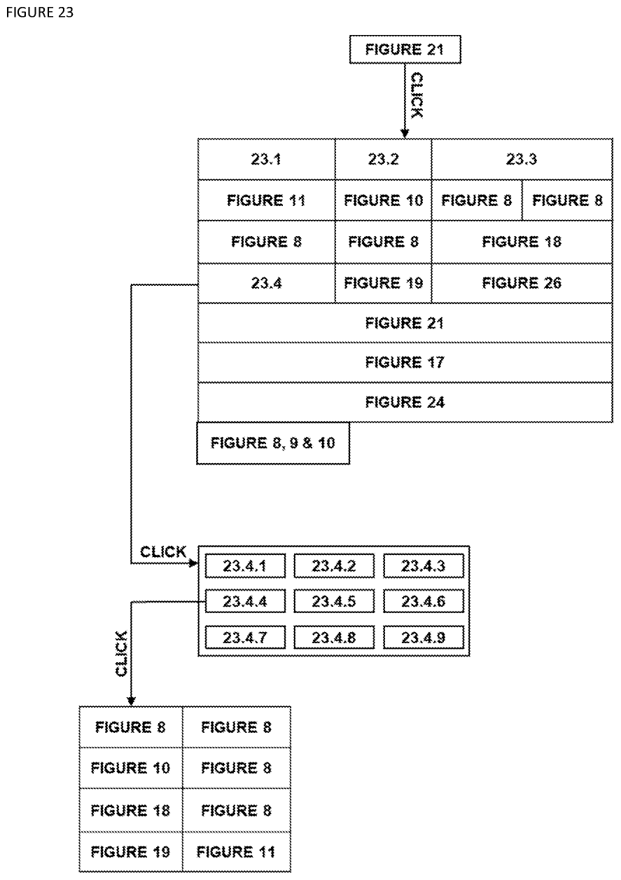

9. FIG. 8 FIG. 8 depicts the screens of 8.1 HOLOGRAM OF A “PATIENT”. User can click to open screens of 8.1.1 ACTUAL PHOTO, 8.1.2 DETAILS, 8.1.3 LIVE GPS COORDINATES, 8.1.4 VITALS FEED, 8.1.4.1 TEMPERATURE, 8.1.4.2 BLOOD PRESSURE, 8.1.4.3 ECG,8.1.4.3.1 LIVE FEED, 8.1.4.3.2 DIGITAL DISPLAYS, 8.1.4.3.3 HISTORICAL FEEDS, 8.1.4.3.3.1 DAY, 8.1.4.3.3.2 WEEK, 8.1.4.3.3.2.1 OPEN SCREENS, 8.1.4.3.3.3 MONTH, 8.1.4.3.3.4 YEAR, 8.1.4.3.4 AI ANALYTICS, 8.1.4.3.4.1 OPENS SCREENS OF AI ANALYTICS, 8.1.4.4 BODY POSTURE, 8.1.4.5 SWEAT, 8.1.4.6 BLOOD SUGAR, 8.1.4.7 HEART RATE, 8.1.4.8 OXYGEN LEVELS, 8.1.4.9 VITAL ORGANS, 8.1.4.9.1 BRAIN, 8.1.4.9.2 LUNG, 8.1.4.9.3 KIDNEY, 8.1.4.9.4 LIVER, 8.1.4.9.5 STOMACH, 8.1.4.9.6 NERVOUS SYSTEM, 8.1.4.9.7 HEART, 8.1.4.9.7.1 LIVE FEED OF ORGAN, 8.1.4.9.7.2 3-D HOLOGRAM OF ORGAN, 8.1.4.9.7.2.1 3-D HOLOGRAM OF LINE HEART OPEN IN AR-MR, 8.1.4.9.7.3 ORGAN SCANS, 8.1.4.9.7.3.1 X-RAY SCANS, 8.1.4.9.7.3.1 DIGITAL RECORD OF SCANS, 8.1.4.9.7.3.2 AI ANALYTICS OF SCANS, 8.1.4.9.7.3.2 MRI SCANS, 8.1.4.9.7.3.3 CT SCANS, 8.1.4.9.7.3.4 ULTRA SOUND SCANS, 8.1.4.9.7.4 DIGITAL DISPLAYS, 8.1.4.10 WEIGHT, 8.1.4.11 BLOOD, 8.1.4.12 MORE VITALS, 8.1.5 RECORDS, 8.1.5.1 MEDICAL RECORDS (REFERS TO FIG. 10 OF THIS DOCUMENT), 8.1.5.2 PERSONAL RECORDS, 8.1.5.3 FAMILY RECORDS (REFERS TO FIG. 9 OF THIS DOCUMENT), 8.1.5.4 MORE RECORDS, 8.1.5.5 BEHAVIOURAL HEALTH, 8.1.6 COMMUNICATION FEED, 8.1.6.1 WHATSAPP, 8.1.6.2 GOOGLE, 8.1.6.3 SPEAKER, 8.1.6.4 MUTE, 8.1.6.5 PHONE, 8.1.6.5.1 DIALPAD, 8.1.6.6 EMAIL, 8.1.6.7 MESSAGE, 8.1.6.8 SKYPE, 8.1.6.8.1 SKYPE VIDEO, 8.1.6.8.2 SKYPE BUTTONS, 8.1.7 VIDEO FEED, 8.1.7.1 NORMAL, 8.1.7.2 NIGHT VISION, 8.1.7.3 THERMAL,8.1.7.3.1 VIDEO FEED, 8.1.7.3.1.1 RECORD, 8.1.7.3.1.2 BUTTONS, 8.1.7.3.1.3 AI ANALYTICS, 8.1.8 SENSOR FEED, 8.1.8.1 PRESSURE, 8.1.8.2 CHARGE, 8.1.8.3 AIR 02, 8.1.8.4 TEMPERATURE, 8.1.8.5 HUMIDITY, 8.1.8.6 NOISE, 8.1.8.6.1 LIVE FEED, 8.1.8.6.2 DIGITAL DISPLAY, 8.1.8.6.3 AI ANALYTICS, 8.1.8.7 LIGHT, 8.1.8.8 ODOUR, 8.1.8.9 VENTILATION, 8.1.8.10 SMOKE

10. FIG. 9 REFERS TO FAMILY RECORDS SECTION OF FIG. 8. User can click to open screens of 9.1.1 SPOUSE, 9.1.1.1 NAME OF SPOUSE, COMMUNICATION FEED OF FIG. 8 IN THIS DOCUMENT,9.1.1.2 DETAILS, 9.1.1.3 LIVE GPS COORDINATES, VITALS FEED SECTION OF FIG. 8 IN THIS DOCUMENT, SENSOR FEED SECTION OF FIG. 8 IN THIS DOCUMENT, VIDEO FEED SECTION OF FIG. 8 IN THIS DOCUMENT, RECORDS SECTION OF FIG. 8 IN THIS DOCUMENT, 9.1.2 FATHER, 9.1.3 MOTHER, 9.1.4 CHILD 1, 9.1.5 CHILD 2

11. FIG. 10 A REFERS TO MEDICAL RECORDS SECTION OF FIG. 8. User can click to open screens of 10A.1 DISEASE RECORDS, 10A.2 TREATMENT RECORDS, 10A.3 SYMPTOM RECORDS, 10A.4 BILLING RECORDS, 10A.5 MEDICAL TRAINING RECORDS, 10A.6 MEDICAL LICENSES, 10A.7 NURSES RECORDS, 10A.7.1 NAME OF NURSE, 10A.7.1.1 NURSE 1, 10A.7.1.1.1 PHOTO OF NURSE, 10A.7.1.1.2 DETAILS, 10A.7.1.1.3 LIVE GPS COORDINATES, SENSOR FEED SECTION OF FIG. 8 IN THIS DOCUMENT, COMMUNICATION FEED SECTION OF FIG. 8 IN THIS DOCUMENT, VIDEO FEED SECTION OF FIG. 8 IN THIS DOCUMENT, VITALS FEED SECTION OF FIG. 8 IN THIS DOCUMENT, RECORDS SECTION OF FIG. 8 IN THIS DOCUMENT, 10A.7.2 TREATMENT BY NURSE, 10A.7.3 DATE OF TREATMENT, 10A.7.4 RESULT OF TREATMENT, 10A.7.4.1 TO 10A.7.4.3 AI, 10A.7.4.4 FURTHER SCREENS TO SHOW AI, 10A.8 DOCTOR RECORDS, 10A.9 SURGERY RECORDS, 10A.10 INSURANCE RECORDS, 10A.11 LAB RECORDS, 10A.12 TESTS RECORDS

12. FIG. 10B depicts the screens of a 10B.1 HOLOGRAM OF A DOCTOR. User can open screens of 10B.2 ACTUAL PHOTO, 10B.3 DETAILS, 10B.4 LIVE GPS COORDINATES, COMMUNICATION FEED SECTION OF FIG. 8 IN THIS DOCUMENT, VIDEO FEED SECTION OF FIG. 8 IN THIS DOCUMENT, SENSOR FEED SECTION OF FIG. 8 IN THIS DOCUMENT, VITALS FEED SECTION OF FIG. 8 IN THIS DOCUMENT, REFERS TO RECORDS SECTION OF FIGS. 8, 9 & 10 IN THIS DOCUMENT, 108.5 DUTY ROSTER (REFERS TO FIG. 11 IN THIS DOCUMENT), 10B.6 SPECIALIZATIONS, 10B.6.1 NEURO (REFERS TO FIG. 12 IN THIS DOCUMENT), 10B.6.2 OPTHO, 10B.6.3 SPINAL, 10B.6.4 CARDIO, 10B.6.5 ENDO, 10B.6.6 DERMA

13. FIG. 11 depicts the screens of 10B REFERS TO DUTY ROSTER SECTION OF FIG. 10B IN THIS DOCUMENT. User can click to open screens of 11.1 DAY, 11.2 WEEK, 11.3 MONTH, 11.4 YEAR, 11.5 HISTORICAL, 11.6 CALENDAR OPENS, 11.6.1 HOUR, 11.6.2 TIME, 11.6.3 DUTY SCHEDULE, 11.6.3.1 OPENS TO FURTHER SCREENS, 11.6.4 TASK COMPLETION, 11.6.4.1 DIAGRAMS, 11.6.4.2 GRAPHS, 11.6.4.3 AI ANALYTICS

14. FIG. 12 depicts the screens for 10B REFERS TO SPECIALIZATIONS SECTION OF FIG. 10B IN THIS DOCUMENT. User can open to click screens of 12.1 PATIENT CASES, 12.2 SURGERIES, 12.2.1 CLICK TO OPEN MORE SCREENS, 12.3 SPECIALIZATIONS AREA, 12.4 COMPLAINTS

15. FIG. 13 depicts the screens of 13.1 HOLOGRAM OF A NURSE which comprises of screens of 10, 11 & 12 REFERS TO FIGS. 10, 11 & 12 MODELLED FOR NURSE

16. FIG. 14 depicts the screens for 14.1 HOLOGRAM OF AN AMBULANCE with 14.1.1 MINI WIND TURBINES and 14.1.2 SOLAR PANELS. User can click to open screens of 14.2 ACTUAL PHOTO OF AMBULANCE, 14.3 LIVE GPS COORDINATES, 14.4 DETAILS, VIDEO FEED SECTION OF FIG. 8 IN THIS DOCUMENT, SENSOR FEED SECTION OF FIG. 8 IN THIS DOCUMENT, COMMUNICATION FEED SECTION OF FIG. 8 IN THIS DOCUMENT, 14.5 AMBULANCE CREW, 14.5.1 TO 14.5.3 REFERS TO CREW (10 REFERS TO FIG. 10 IN THIS DOCUMENT WHICH OPENS FOR EACH CREW0. User can click to open screens for 14.6 EQUIPMENT/INVENTORY, 14.6.1 TO 14.6.3 REFERS TO EQUIPMENT'S (15 REFERS TO FIG. 15 IN THIS DOCUMENT), 14.7 SELF DRIVING CONTROLS (16 REFERS TO FIG. 16 IN THIS DOCUMENT), 14.8 POWER CONTROLS (17 REFERS TO FIG. 17 IN THIS DOCUMENT), 14.9 AMBULANCE DIGITAL DISPLAYS, 14.9.1 SPEED, 14.9.2 DISTANCE, 14.9.3 ESTIMATED TIME OF ARRIVAL,14.9.4 FIRST RESPONSE TIME, 14.10 MANUALS (18 REFER TO FIG. 18 IN THIS DOCUMENT), 14.11 MANUFACTURER (19 REFER TO FIG. 19 IN THIS DOCUMENT), 4.12 ADVERTISER (11 REFER TO ROSTER SECTION OF FIG. 11 IN THIS DOCUMENT)_

17. FIG. 15 depicts the screens for 14 REFER TO EQUIPMENT/INVENTORY SECTION OF FIG. 14 IN THIS DOCUMENT. User can click to open screens of 15.1 ACTUAL PHOTO OF EQUIPMENT,15.2 DETAILS, 15.3 LIVE GPS COORDINATES, SENSOR FEED SECTION OF FIG. 8 IN THIS DOCUMENT, MANUFACTURER SECTION OF FIG. 19 IN THIS DOCUMENT, MANUALS SECTION OF FIG. 18 IN THIS DOCUMENT, 15.4 EQUIPMENT CONTROL BUTTONS, 15.4.1 TO 15.4.10 ARE EQUIPMENT CONTROL BUTTONS FROM 1 TO 10, 15.4.5.1 CLICK TO CONTROL OPERATION OF EQUIPMENT, VIDEO FEED SECTION OF FIG. 8 IN THIS DOCUMENT. User can click to open screens of 15.5 EQUIPMENT PARTS, 15.5.1 TO 15.5.4 ARE EQUIPMENT PARTS, 15.5.4.1 HOLOGRAM OF A PART, 15.5.4.2 ACTUAL PHOTO OF PART, 15.5.4.3 DETAILS, SENSOR FEED SECTION OF FIG. 8 IN THIS DOCUMENT, REFER TO MANUFACTURER SECTION OF FIG. 19 IN THIS DOCUMENT, 15.5.4.4 PART CONTROL BUTTONS, 15.5.4.4.1 CLICK TO CONTROL OPERATION OF THAT PART, REFER TO MANUALS SECTION OF FIG. 18 IN THIS DOCUMENT

18. FIG. 16 depicts the screens of 14 REFER TO SELF DRIVING CONTROLS SECTION OF FIG. 14 IN THIS DOCUMENT. User can click to open screens of 16.1 LIVE VIDEO FEED OF AI DRIVING, 16.2 DIGITAL DISPLAYS, 16.2.1 DISPLAYS, 16.2.1.1 SPEED, 16.2.1.2 FUEL, 16.2.1.3 POWER, 16.2.1.4 RPM, 16.2.1.5 BRAKE FLUID, 16.2.1.6 AIR PRESSURE, 16.3 LOCATION MAP, 16.4 LIVE VIDEO FEED, 16.5 ESTIMATED TIME OF ARRIVAL

19. FIG. 17 depicts the screens of 14 REFER TO SELF POWER CONTROLS SECTION OF FIG. 14 IN THIS DOCUMENT. User can click to open screens of 17.1 CURRENT POWER CONSUMPTION, 17.1.1 OPENS SCREENS, 17.2 HISTORICAL POWER CONSUMPTION, 17.2.1 HISTORICAL RECORDS, 17.2.1.1 DAY, 17.2.1.2 WEEK, 17.2.1.3 MONTH, 17.2.1.4 YEAR, 17.2.2 AI ANALYTICS, 17.2.2.1 DAY, 17.2.2.2 WEEK, 17.2.2.3 MONTH, 17.2.2.4 YEAR, 17.3 CURRENT POWER STORAGE, 17.3.1 SOLAR, 17.3.1.1 SOLAR BATTERY AVAILABLE, 17.3.1.1.1 GAUGES, 17.3.2 WIND, 17.3.2.1 WIND ENERGY

20. FIG. 18 depicts the screens of 14 REFER TO SELF MANUALS SECTION OF FIG. 14 IN THIS DOCUMENT. User can click to open screens of 18.1 OPERATION MANUALS, 18.1.1 DIGITAL SCANS OPEN, 18.2 MATERIALS USED FOR CONSTRUCTION, 18.2.1 DIGITAL SCANS OPEN, 18.3 BLUEPRINTS, 18.3.1 DIGITAL SCANS OPEN, 18.4 MAINTENANCE, 18.4.1 DIGITAL MAINTENANCE RECORDS, 18.4.2 DIGITAL MAINTENANCE SCHEDULES (18.4.2.1, 18.4.2.2, 18.4.2.3, 18.4.2.4) 21. FIG. 19 depicts the screens of 14 REFER TO MANUFACTURER SECTION OF FIG. 14 IN THIS DOCUMENT. User can click to open screens of 19.1 DETAILS OF MANUFACTURER, 19.1.1 SCREENS WITH DETAILS OPEN, 19.2 COMMUNICATION FEED TO MANUFACTURER. REFERS TO COMMUNICATION FEED SECTION OF FIG. 8 IN THIS DOCUMENT.

22. FIG. 20 depicts the screens of 14 REFER TO ADVERTISER SECTION OF FIG. 14 IN THIS DOCUMENT. User can click to open screens of 20.1 DETAILS OF ADVERTISER, 20.1.1 SCREENS WITH DETAILS OPEN, 20.2 COMMUNICATION FEED TO ADVERTISER, REFERS TO COMMUNICATION FEED SECTION OF FIG. 8 IN THIS DOCUMENT, 20.3 HISTORICAL RECORDS, 20.3.1 DIGITAL SCANS OF ALL ADVERTISER RECORDS

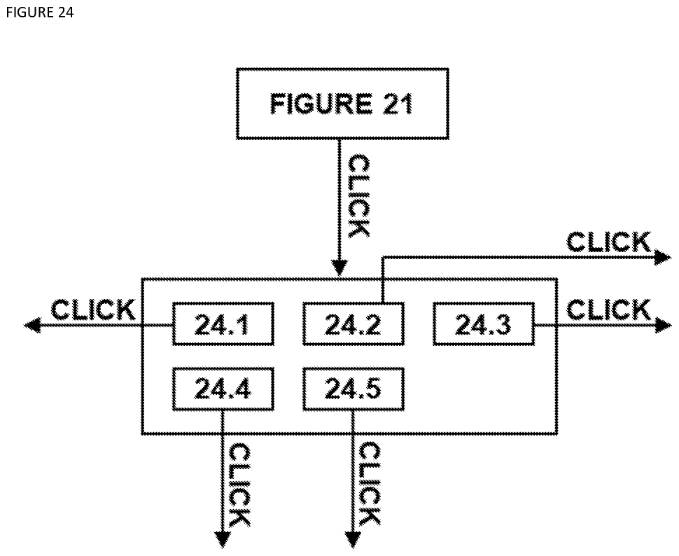

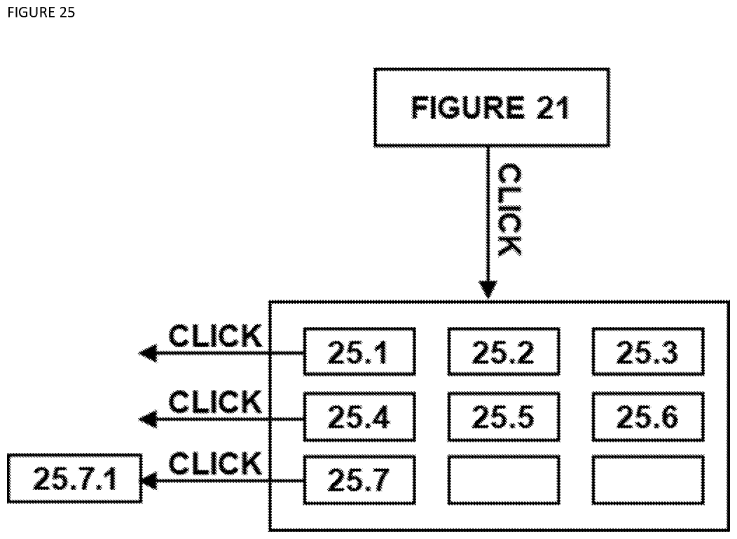

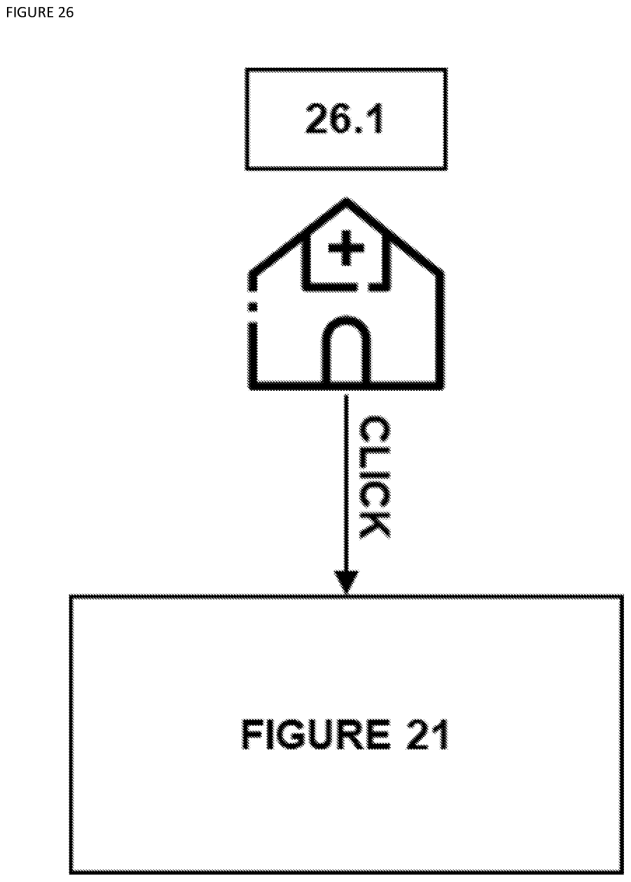

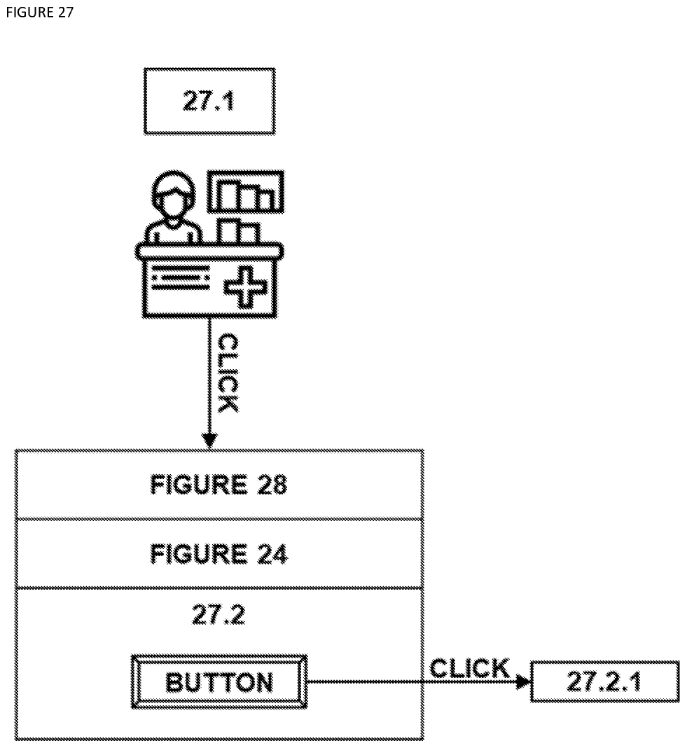

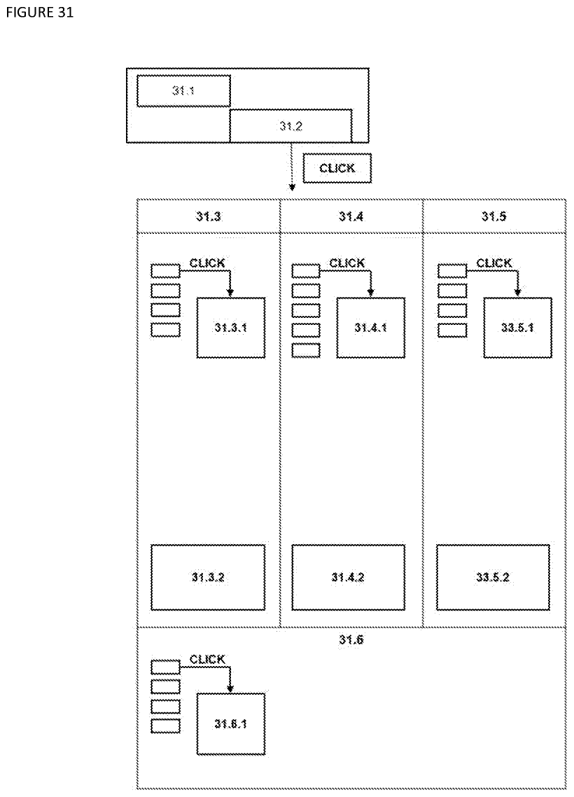

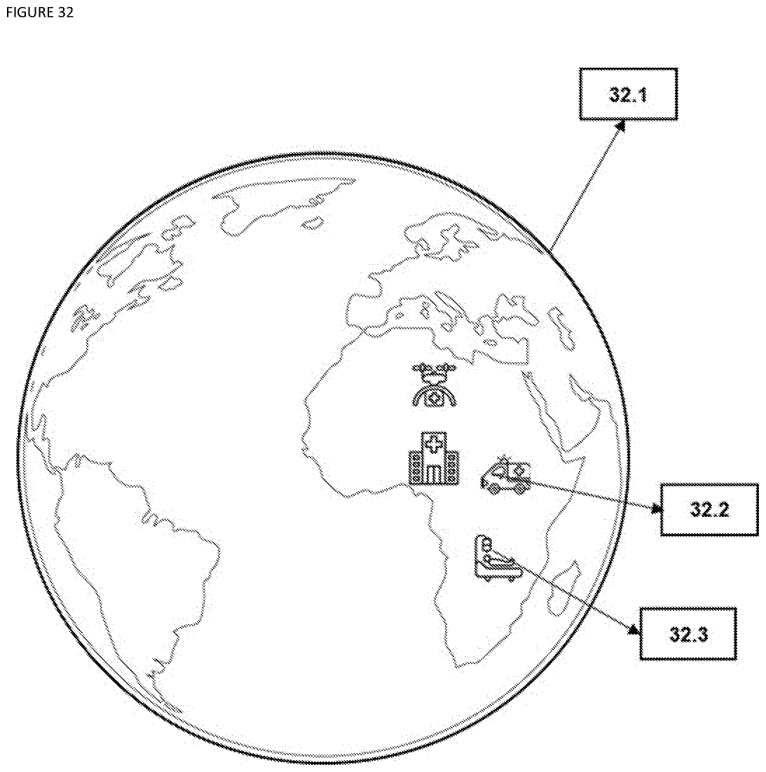

23. FIG. 21 depicts the screens of 21.1 HOSPITALS with 21.1.1 WIND TURBINES and 21.1.2 SOLAR PANELS. User can click to open screens of 21.2 ACTUAL PHOTO OF HOSPITALS, 21.3 LIVE GPS COORDINATES, 21.4 DETAILS OF HOSPITALS, SENSOR FEED OF FIG. 8 OF THIS DOCUMENT, VIDEO FEED OF FIG. 8 OF THIS DOCUMENT, COMMUNICATION FEED OF FIG. 8 OF THIS DOCUMENT, 21.5 REFERS AMBULANCE VEHICLES , 1,2 & 3 REFERS TO NUMBER ALLOCATED TO VARIOUS AMBULANCE VEHICLES (14 REFERS TO FIG. 14 MAPPED FOR EACH VEHICLE), MANUALS SECTION OF FIG. 18 OF THIS DOCUMENT, MANUFACTURER SECTION OF FIG. 19 OF THIS DOCUMENT, ADVERTISER SECTION OF FIG. 20 OF THIS DOCUMENT, STAFF SECTION OF FIG. 10 OF THIS DOCUMENT, PATIENT SECTION OF FIG. 8 OF THIS DOCUMENT, 21.6 UTILITY CONSUMPTION, 21.6.1 WATER21.6.2 GAS, 21.6.3 ENERGY ,21.6.4 GARBAGE, 22 REFERS TO FIG. 22 OF THIS DOCUMENT, 21.6.5 SEWAGE, 21.6.6 MEDICAL WASTE, 21.6.7 OXYGEN, 21.6.8 LIGHTING, 21.7 PARKING LOT (32 REFERS TO FIG. 32 OF THIS DOCUMENT), POWER GENERATION FEED OF SECTION 17 FROM THIS DOCUMENT, 21.8 3D MEDICAL PRINTER (31 REFERS TO FIG. 31 OF THIS DOCUMENT), 21.9 DEPARTMENTS, 21.9.1 TO 29.3 REFERS TO VARIOUS WARDS OF HOSPITALS (23 REFERS TO FIG. 23 OF THIS DOCUMENT), 21.9.4 DEPARTMENTS, 21.9.5 LABS, 21.9.6 DIAGNOSTICS SENSORS, 11 REFERS TO ROSTERS OF HOSPITAL OF FIG. 11 FROM THIS DOCUMENT, 21.10 WASTE MANAGEMENT (24 REFERS TO FIG. 24 OF THIS DOCUMENT), 21.11 EQUIPMENT′S/INVENTORY (15 REFERS TO FIG. 15 OF THIS DOCUMENT), 21.12 PATIENT ASSISTANCE CENTRE (25 REFERS TO FIG. 25 OF THIS DOCUMENT), 21.13 RECORDS (8,9 &10 REFERS TO FIGS. 8,9 & 10 MAPPED FOR THIS SECTION), 21.14 HOSPITAL ERP, 21.14.1 LINKS TO ERP, 21.15 BILLING ERP, 21.16 FINANCIAL ERP

24. FIG. 22 depicts the screens of the 22.1 NAME OF UTILITY which opens screens of 22.1.1 DAY CONSUMPTION, 22.1.2 HOUR CONSUMPTION, 22.1.3 WEEK CONSUMPTION, 22.1.4 MONTH CONSUMPTION, 22.1.4.1 DAY, 22.1.4.2 QUANTITY, 22.1.4.3 GRAPHS/DIAGRAMS, 22.1.4.4 AI, 22.1.4.4.1 OPENS “AI” BASED ANALYTICS SCREENS, 22.1.4.5 DIAGRAMS/GRAPHS AND SCREENS, 22.1.5 YEAR CONSUMPTION, 22.1.6 DECADE CONSUMPTION, SENSOR SECTION OF FIG. 8 MODELLED FOR EACH UTILITY AS REQUIRED, 22.2 UTILITY BILLS, 22.2.1 MONTH, 22.2.1.1 RECORD OPENS, 22.2.2 YEAR, 22.2.2.1 RECORD OPENS, 22.2.3 DECADE, 22.2.3.1 RECORD OPENS, 22.3 UTILITY PROVIDER, COMMUNICATION FEED OF FIG. 8 FROM THIS DOCUMENT, 22.3.1 DETAILS OF UTILITY PROVIDER SUCH AS NAME, ADDRESS ETC., 22.4 DETAILS OF UTILITY, 22.4.1 TYPE, 22.4.2 QUALITY, 22.4.2.1 CHEMICAL COMPOSITION, 22.4.2.1.1 OPENS SCREENS, 22.4.2.2 SPECIFICATION OF UTILITY

25. FIG. 23 depicts the screens of a 21 REFER TO DEPARTMENT SECTION OF FIG. 21 IN THIS DOCUMENT. User can click to open screens of 23.1 ACTUAL PHOTO, 23.2 GPS LOCATION, 23.3 DETAILS, ROSTERS SECTION OF FIG. 11 IN THIS DOCUMENT, CREW/STAFF SECTION OF FIG. 10 IN THIS DOCUMENT, VIDEO FEED SECTION OF FIG. 8 IN THIS DOCUMENT, SENSOR FEED SECTION OF FIG. 8 IN THIS DOCUMENT, COMMUNICATION FEED SECTION OF FIG. 8 IN THIS DOCUMENT, PATIENTS SECTION OF FIG. 8 IN THIS DOCUMENT, MANUALS SECTION OF FIG. 18 IN THIS DOCUMENT, 23.4 HOSPITAL BED CONFIGURATION, 23.4.1 TO 23.4.9 ARE HOSPITAL BEDS CONFIGURATION, PATIENT SECTION OF FIG. 8 IN THIS DOCUMENT, COMMUNICATION FEED SECTION OF FIG. 8 IN THIS DOCUMENT, DOCTOR SECTION OF FIG. 8 IN THIS DOCUMENT, VIDEO FEED SECTION OF FIG. 8 IN THIS DOCUMENT, MANUALS SECTION OF FIG. 18 IN THIS DOCUMENT, SENSOR FEED SECTION OF FIG. 8 IN THIS DOCUMENT, MANUFACTURER SECTION OF FIG. 19 IN THIS DOCUMENT, ROSTERS SECTION OF FIG. 11 IN THIS DOCUMENT, MANUFACTURER SECTION OF FIG. 19 IN THIS DOCUMENT, INVENTORY SECTION OF FIG. 26 IN THIS DOCUMENT, UTILITY CONSUMPTION SECTION OF FIG. 21 IN THIS DOCUMENT, POWER GENERATION FEED SECTION OF FIG. 17 IN THIS DOCUMENT, WASTE MANAGEMENT SECTION OF FIG. 24 IN THIS DOCUMENT.

26. FIG. 24 depicts the screens of 21 REFER TO WASTE MANAGEMENT SECTION OF FIG. 21 IN THIS DOCUMENT. User can click to open screens of 24.1 WASTE SEGREGATION, 24.2 WASTE RECYCLING, 24.3 WASTE DISPOSAL, 24.4 WASTE ENERGY GENERATION, 24.5 WASTE TRANSPORTATION 27. FIG. 25 depicts the screens of 21 REFER TO PATIENT ASSISTANCE CENTRE SECTION OF FIG. 21 IN THIS DOCUMENT. User can click to open screens of 25.1 PATIENT BATHS, 25.2 PATIENT FOOD, 25.3 PATIENT MEDICATION, 25.4 PATIENT TELEMEDICINE, 25.5 INTRAVENOUS SERVICES, 25.6 VENTILATOR SERVICES, 25.7 OXYGEN SERVICES, 25.7.1 OPENS TO FURTHER SCREENS

28. FIG. 26 depicts the screens of 26.1 HOLOGRAM OF A CLINIC which are to be modelled on 21 REFERS TO FIG. 21 MODELLED FOR A CLINIC

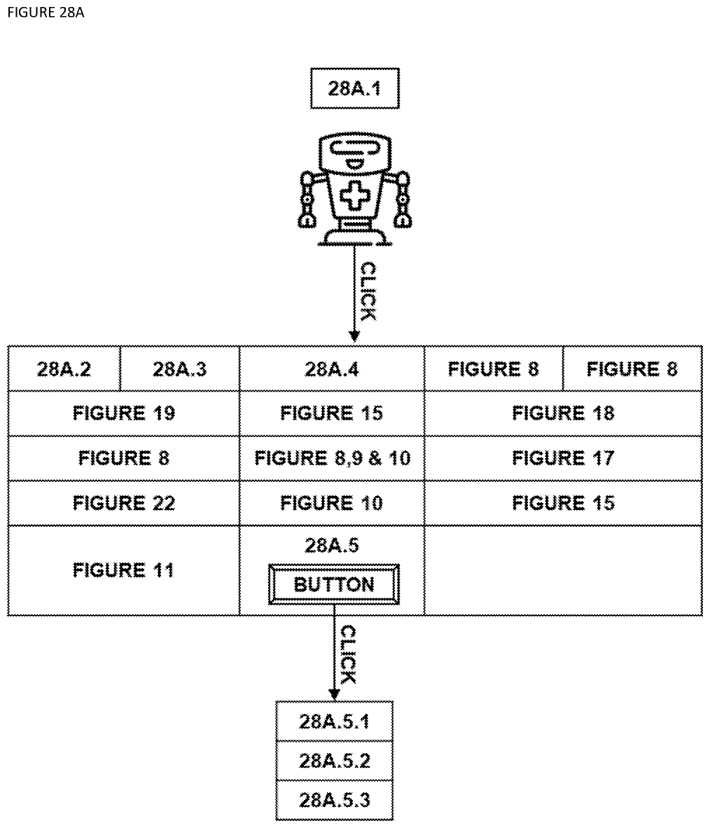

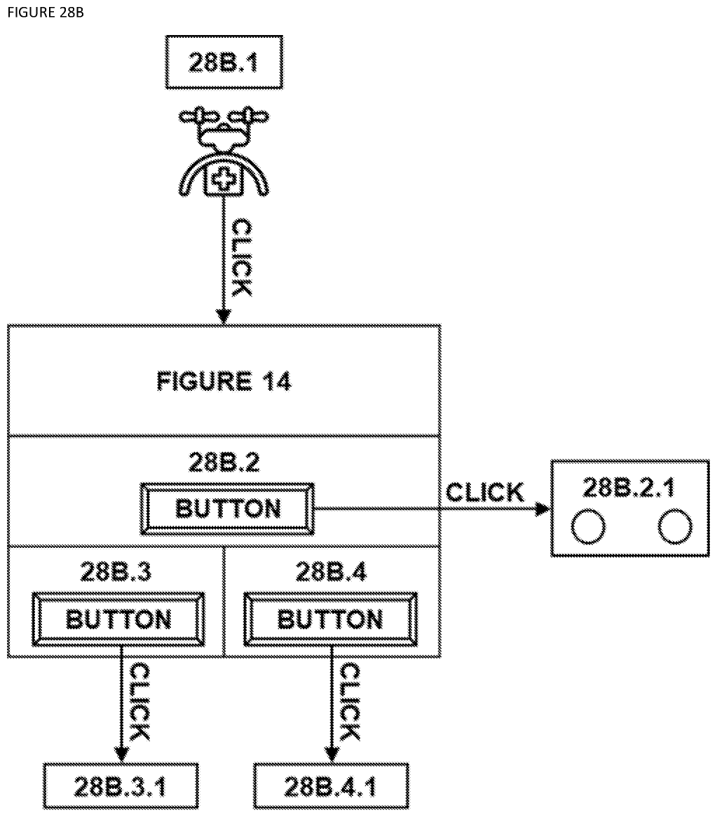

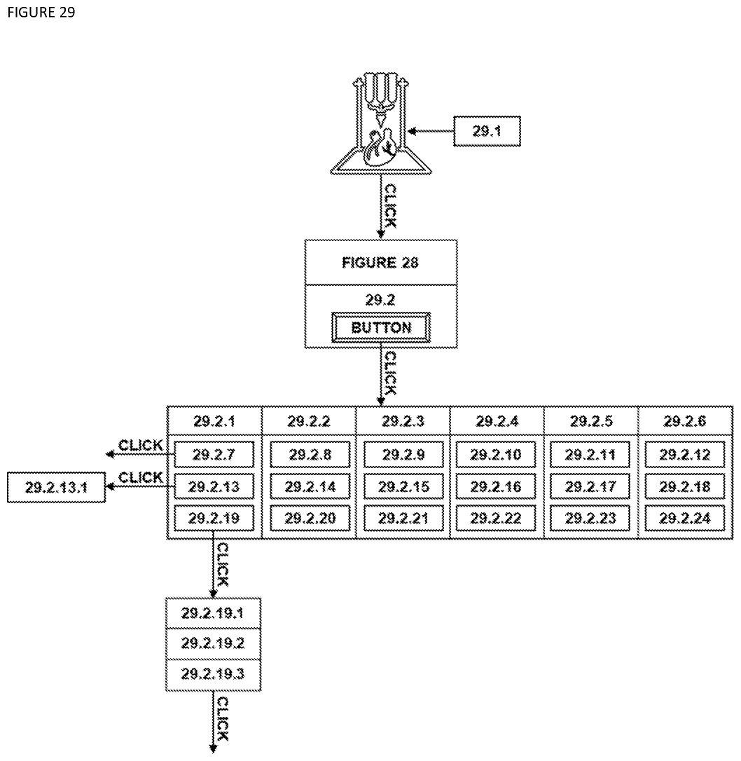

29. FIG. 27 depicts the 27.1 HOLOGRAM OF A PHARMACY. User 28 REFERS TO FIG. 28 OF THIS DOCUMENT which leads to screens of 24 REFERS TO FIG. 24 OF THIS DOCUMENT, 27.2 PHARMACY ERP, 27.2.1 LINKS TO PHARMACY ERP SYSTEMS

30. FIG. 28A depicts screens of a 28A.1 HOLOGRAM OF A MEDICAL ROBOT. User can click to open screens of 28A.2 ACTUAL PHOTO, 28A.3 DETAILS, 28A.4 LIVE GPS COORDINATES, SENSOR FEED SECTION OF FIG. 8 IN THIS DOCUMENT, VIDEO FEED SECTION OF FIG. 8 IN THIS DOCUMENT, MANUFACTURER SECTION OF FIG. 19 IN THIS DOCUMENT, EQUIPMENT′S/INVENTORY SECTION OF FIG. 15 IN THIS DOCUMENT, MANUALS SECTION OF FIG. 18 IN THIS DOCUMENT, COMMUNICATION FEED SECTION OF FIG. 8 IN THIS DOCUMENT, REFER TO RECORDS SECTION OF FIGS. 8, 9 & 10 IN THIS DOCUMENT, POWER GENERATION FEED SECTION OF FIG. 8 IN THIS DOCUMENT, UTILITY CONSUMPTION SECTION OF FIG. 22 IN THIS DOCUMENT, STAFF/CREW SECTION OF FIG. 18 IN THIS DOCUMENT, ROBOT OPERATIONS CONTROL BUTTONS SECTION OF FIG. 15 IN THIS DOCUMENT, ROSTERS SECTION OF FIG. 11 IN THIS DOCUMENT, 28A.5 AI AUTONOMOUS, 28A.5.1 LIVE FEED, 28A.5.2 LIVE RECORDING, 28A.5.3 DIGITAL DISPLAYS

31. FIG. 28B depicts the screens of a 28B.1 HOLOGRAM OF A MEDICAL DRONE. User can click to open screens of REFERS TO FIG. 14 IN THIS DOCUMENT, 28B.2 LOAD CAPACITY, 28B.2.1 DISPLAYS, 28B.3 LOADING CHAMBER, 28B.3.1 OPENS FURTHER SCREENS, 28B.4 LOADING CHAMBER REFRIGERATOR, 28B.4.1 OPENS FURTHER SCREENS

32. FIG. 29 depicts the screens of 29.1 HOLOGRAM OF A MEDICAL 3-D PRINTER. User can click to open screens of 28 REFERS TO FIG. 28 IN THIS DOCUMENT, 29.2 PRINTING SELECTIONS, 29.2.1 HUMAN TISSUE PRINTING, 29.2.2 HUMAN BONE PRINTING, 29.2.3 PROSTHETICS PRINTING, 29.2.4 DRUG PRINTING, 29.2.5 DNA PRINTING, 29.2.6 BLOOD PRINTING, 29.2.7 TO 29.2.12 ARE DESIGN SELECTIONS, 29.2.13 TO 29.2.18 ARE MATERIAL SELECTIONS, 29.2.13.1 TO OPEN FURTHER SCREENS, 29.2.19 TO 29.2.24 ARE PRINTS, 29.2.19.1 PRINT DISPLAYS, 29.2.19.2 VIDEO FEED, 29.2.19.3 PRINTING ANALYTICS

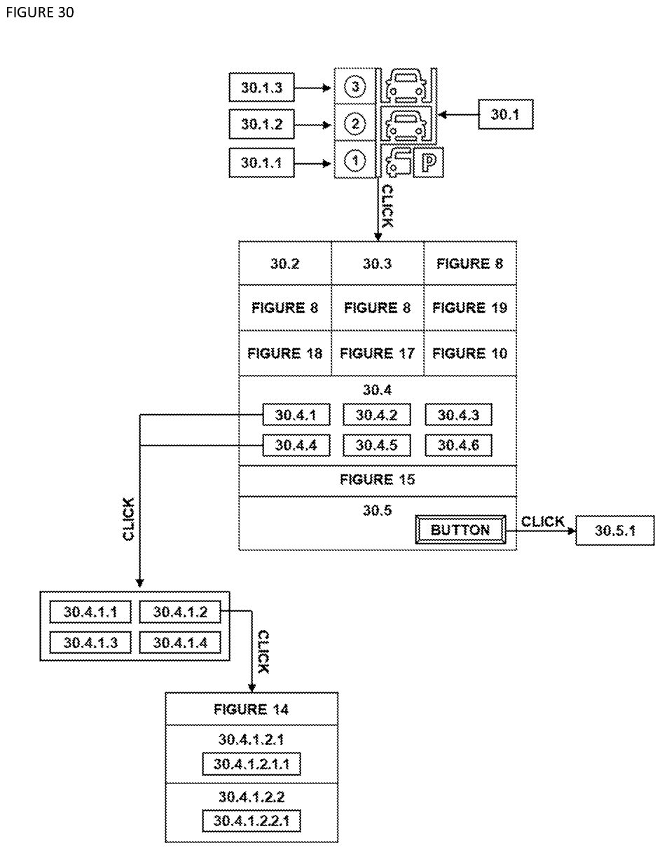

33. FIG. 30 depicts screens of 30.1 HOLOGRAM OF A PARKING. User can click to open screens of 30.1.1 PARKING LEVEL 1, 30.1.2 PARKING LEVEL 2, 30.1.3 PARKING LEVEL 3, 30.2 ACTUAL PHOTO, 30.3 LIVE GPS COORDINATES, VIDEO FEED SECTION OF FIG. 8 IN THIS DOCUMENT, COMMUNICATION FEED SECTION OF FIG. 8 IN THIS DOCUMENT, SENSOR FEED SECTION OF FIG. 8 IN THIS DOCUMENT, MANUFACTURER SECTION OF FIG. 19 IN THIS DOCUMENT, MANUALS SECTION OF FIG. 18 IN THIS DOCUMENT,POWER GENERATION FEED SECTION OF FIG. 17 IN THIS DOCUMENT, 10 REFER TO STAFF/CREW SECTION OF FIG. 10 IN THIS DOCUMENT, 30.4 PARKING SPACES/LEVELS, 30.4.1 TO 30.4.6 ARE NO PARKING SPACES/LEVELS, 30.4.1.1 TO 30.4.1.4 ARE VEHICLES IN EACH PARKING LEVEL, 14 REFERS TO FIG. 14 IN THIS DOCUMENT, 30.4.1.2.1 CURRENT PARKING TIME , 30.4.1.2.1.1 DIGITAL CLOCK, 30.4.1.2.2 CURRENT PARKING CHARGES, 30.4.1.2.2.1 DIGITAL CLOCK, 15 REFERS TO FIG. 15 IN THIS DOCUMENT, 30.5 PARKING LOT ERP, 30.5.1 LINK TO ERP SYSTEMS

34. FIG. 31 depicts the 31.1 ZEUS CENTRAL COMMAND and screens of 31.2 ZEUS AI. User can click to open screens of 31.3 DESCRIPTIVE ANALYTICS AND OPERATIONS, 31.3.1 SCREENS OPEN FOR EACH PARAMETER WITH ALL KINDS OF ANALYTICS, PLANNING, OPERATIONS, 31.3.2 FOR ALL POSSIBLE AND REQUIRED PARAMETERS. User can click to open screens of 31.4 PREDICTIVE ANALYTICS AND OPERATIONS, 31.4.1 SCREENS OPEN FOR EACH PARAMETER WITH ALL KINDS OF ANALYTICS, PLANNING OPERATIONS, 31.4.2 FOR ALL POSSIBLE AND REQUIRED PARAMETERS. User can click to open screens of 31.5 PRESCRIPTIVE ANALYTICS AND OPERATIONS, 31.5.1 SCREENS OPEN FOR EACH PARAMETER WITH ALL KINDS OF ANALYTICS, PLANNING OPERATIONS, 31.5.2 FOR ALL POSSIBLE AND REQUIRED PARAMETERS, 31.6 AI COGNITIVE ANALYTICS OPERATIONS (WARNING: AUTONOMY GIVEN TO AI), 31.6.1 SCREENS OPEN FOR SELECTED PARAMETERS.

35. FIG. 32 depicts the FIG. 32.1 HOLOGRAM OF ROTATING EARTH and FIGS. 32.2 TO 32.3 REPRESENTS HOLOGRAM OF ALL ASSETS WHICH CAN BE CLICKED TO OPEN THEIR SCREENS

### LEGEND FOR DRAWINGS

Legend for FIG. 1:

1.1 User

1.1.1 SMART EYEWEAR

1.2 HOLOGRAM BOX IN AR-MR

1.3 ZEUS

1.3.1 HOLOGRAM TEXT IN AR-MR

1.4 ENTER

1.4.1 CLICKABLE BUTTON OR VOICE COMMAND ACTIVATED

Legend for FIG. 2:

1.4 ENTER

2.1 ZEUS AI—ARTIFICIAL INTELLIGENCE

2.1.1 PATIENT MANAGEMENT

2.1.2 HOSPITAL MANAGEMENT

2.1.3 PHARMACY MANAGEMENT

2.1.4 AMBULANCE/EMERGENCY MANAGEMENT

2.1.5 MEDICAL WASTE DISPOSAL MANAGEMENT

2.1.6 MEDICAL MANUFACTURING MANAGEMENT

2.1.7 MEDICAL DRONES MANAGEMENT

2.1.8 MEDICAL DOCTORS AND NURSES MANAGEMENT

2.1.9 MEDICAL ROBOTICS MANAGEMENT

2.1.10 PATIENT AI

2.1.11 HOSPITAL AI

2.1.12 PHARMACY AI

2.1.13 AMBULANCE/EMERGENCY AI

2.1.14 MEDICAL WASTE DISPOSAL AI

2.1.15 MEDICAL MANUFACTURING AI

2.1.16 MEDICAL DRONES AI

2.1.17 MEDICAL DOCTORS AND NURSES AI

2.1.18 MEDICAL ROBOTICS AI

2.2 EVERY BOX IS CLICKABLE

2.3 HOLOGRAM IN AR-MR

Legend for FIG. 3:

3.1 HOLOGRAM BOX IN AR-MR

3.2 HOSPITAL COMMAND

3.2.1 INDIA

3.2.2 RUSSIA

3.2.3 USA

3.2.3.1 CLICKABLE BUTTONS OF ALL COUNTRIES

3.2.4 CHINA

3.2.5 UK

3.2.6 FRANCE

3.3 WORLD

3.3.1 CLICKABLE BUTTON TO COMBINE ALL COUNTRIES OF THE WORLD. TAKES YOU TO A 3-D EARTH HOLOGRAM

Legend for FIG. 4:

3.2.1 INDIA

4.1 HOLOGRAM MAP

Legend for FIG. 5:

5.1 HOLOGRAM MAP

5.2 ENTIRE COUNTRY IS DIVIDED INTO MICRO “GPS GRIDS”

5.3 BACK

5.3.1 CLICK

5.4 CENTRAL COMMAND

2 REFERS TO FIG. 2 OF THIS DOCUMENT

Legend for FIG. 6:

6.1 HOLOGRAM BOX

6.1.1 BACK

6.1.1.1 BUTTON TAKES YOU TO BACKSCREEN

6.1.2 CENTRAL COMMAND

2 REFERS TO FIGURE TO OF THIS DOCUMENT

6.1.3 ALL

6.1.3.1 BUTTON WHICH COMBINES ALL ASSETS

6.1.4 SATELLITE IMAGE

6.1.4.1 CLICK ON THIS AND GRID WILL SHOW ITS SATELLITE IMAGE

6.2 LIST OF ALL MEDICAL “ASSETS”

6.3 EXPANDED GRID

6.4 USER

6.4.1 SMART GLASS

6.5 FLOOR GROUND OR AIR

6.5.1 GRID

Legend for FIG. 7:

7.1 AIR VIEW

7.2 GRID

7.2.1 HOSPITAL

7.2.2 PATIENT

7.2.3 AMBULANCE

7.2.4 MEDICAL DRONE

7.2.5 PHARMACY

7.2.6 MEDICAL WASTE DEPOSIT UNIT

7.2.7 CLINIC

7.2.8 DOCTOR

7.2.9 MEDICAL MANUFACTURER

7.2.10 NURSE

7.3 GROUND VIEW

7.4 GRID

7.4.1 NURSE

7.4.2 HOSPITAL 7.4.3 MEDICAL DRONE 7.4.4 PATIENT 7.4.5 AMBULANCE 7.4.6 PHARMACY 7.4.7 MEDICAL MANUFACTURER 7.4.8 DOCTOR 7.4.9 CLINIC 7.4.10 MEDICAL ROBOT 7.4.11 MEDICAL WASTE DEPOSIT UNIT

Legend for FIG. 8

| | |
|---|---|
| 8.1 | HOLOGRAM OF A “PATIENT” |
| 8.1.1 | ACTUAL PHOTO |
| 8.1.2 | DETAILS |
| 8.1.3 | LIVE GPS COORDINATES |
| 8.1.4 | VITALS FEED |
| 8.1.4.1 | TEMPERATURE |
| 8.1.4.2 | BLOOD PRESSURE |
| 8.1.4.3 | ECG |
| 8.1.4.3.1 | LIVE FEED |
| 8.1.4.3.2 | DIGITAL DISPLAYS |
| 8.1.4.3.3 | HISTORICAL FEEDS |
| 8.1.4.3.3.1 | DAY |
| 8.1.4.3.3.2 | WEEK |
| 8.1.4.3.3.2.1 | OPEN SCREENS |
| 8.1.4.3.3.3 | MONTH |
| 8.1.4.3.3.4 | YEAR |
| 8.1.4.3.4 | AI ANALYTICS |
| 8.1.4.3.4.1 | OPENS SCREENS OF AI ANALYTICS |
| 8.1.4.4 | BODY POSTURE |
| 8.1.4.5 | SWEAT |
| 8.1.4.6 | BLOOD SUGAR |
| 8.1.4.7 | HEART RATE |
| 8.1.4.8 | OXYGEN LEVELS |
| 8.1.4.9 | VITAL ORGANS |
| 8.1.4.9.1 | BRAIN |
| 8.1.4.9.2 | LUNG |
| 8.1.4.9.3 | KIDNEY |
| 8.1.4.9.4 | LIVER |
| 8.1.4.9.5 | STOMACH |
| 8.1.4.9.6 | NERVOUS SYSTEM |
| 8.1.4.9.7 | HEART |
| 8.1.4.9.7.1 | LIVE FEED OF ORGAN |
| 8.1.4.9.7.2 | 3-D HOLOGRAM OF ORGAN |
| 8.1.4.9.7.2.1 | 3-D HOLOGRAM OF LINE HEART OPEN IN AR-MR |
| 8.1.4.9.7.3 | ORGAN SCANS |
| 8.1.4.9.7.3.1 | X-RAY SCANS |
| 8.1.4.9.7.3.1 | DIGITAL RECORD OF SCANS |
| 8.1.4.9.7.3.2 | AI ANALYTICS OF SCANS |
| 8.1.4.9.7.3.2 | MRI SCANS |
| 8.1.4.9.7.3.3 | CT SCANS |
| 8.1.4.9.7.3.4 | ULTRA SOUND SCANS |
| 8.1.4.9.7.4 | DIGITAL DISPLAYS |
| 8.1.4.10 | WEIGHT |
| 8.1.4.11 | BLOOD |
| 8.1.4.12 | MORE VITALS |
| 8.1.5 | RECORDS |
| 8.1.5.1 | MEDICAL RECORDS 10 REFERS TO FIG. 10 OF THIS |
| | DOCUMENT |
| 8.1.5.2 | PERSONAL RECORDS |
| 8.1.5.3 | FAMILY RECORDS 9 REFERS TO FIG. 9 OF THIS |
| | DOCUMENT |

Legend for FIG. 8

| | |
|---|---|
| 8.1.5.4 | MORE RECORDS |
| 8.1.5.5 | BEHAVIOURAL HEALTH |
| 8.1.6 | COMMUNICATION FEED |
| 8.1.6.1 | WHATSAPP |
| 8.1.6.2 | GOOGLE |
| 8.1.6.3 | SPEAKER |
| 8.1.6.4 | MUTE |
| 8.1.6.5 | PHONE |
| 8.1.6.5.1 | DIALPAD |
| 8.1.6.6 | EMAIL |
| 8.1.6.7 | MESSAGE |
| 8.1.6.8 | SKYPE |
| 8.1.6.8.1 | SKYPE VIDEO |
| 8.1.6.8.2 | SKYPE BUTTONS |
| 8.1.7 | VIDEO FEED |
| 8.1.7.1 | NORMAL |
| 8.1.7.2 | NIGHT VISION |
| 8.1.7.3 | THERMAL |
| 8.1.7.3.1 | VIDEO FEED |
| 8.1.7.3.1.1 | RECORD |
| 8.1.7.3.1.2 | BUTTONS |
| 8.1.7.3.1.3 | AI ANALYTICS |
| 8.1.8 | SENSOR FEED |
| 8.1.8.1 | PRESSURE |
| 8.1.8.2 | CHARGE |
| 8.1.8.3 | AIR O2 |
| 8.1.8.4 | TEMPERATURE |
| 8.1.8.5 | HUMIDITY |
| 8.1.8.6 | NOISE |
| 8.1.8.6.1 | LIVE FEED |
| 8.1.8.6.2 | DIGITAL DISPLAY |
| 8.1.8.6.3 | AI ANALYTICS |
| 8.1.8.7 | LIGHT |
| 8.1.8.8 | ODOUR |
| 8.1.8.9 | VENTILATION |
| 8.1.8.10 | SMOKE |

Legend for FIG. 9

8 REFERS TO FAMILY RECORDS SECTION OF FIG. 8

9.1.1 SPOUSE

9.1.1.1 NAME OF SPOUSE

8 REFERS TO COMMUNICATION FEED OF FIG. 8 IN THIS DOCUMENT

9.1.1.2 DETAILS

9.1.1.3 LIVE GPS COORDINATES

8 REFERS TO VITALS FEED SECTION OF FIG. 8 IN THIS DOCUMENT

8 REFERS TO SENSOR FEED SECTION OF FIG. 8 IN THIS DOCUMENT

8 REFERS TO VIDEO FEED SECTION OF FIG. 8 IN THIS DOCUMENT

8 REFERS TO RECORDS SECTION OF FIG. 8 IN THIS DOCUMENT

9.1.2 FATHER

9.1.3 MOTHER

9.1.4 CHILD 1

9.1.5 CHILD 2

Legend for FIG. 10A

8 REFERS TO MEDICAL RECORDS SECTION OF FIG. 8

10A.1 DISEASE RECORDS

10A.2 TREATMENT RECORDS

10A.3 SYMPTOM RECORDS

10A.4 BILLING RECORDS

10A.5 MEDICAL TRAINING RECORDS

10A.6 MEDICAL LICENSES

10A.7 NURSES RECORDS

10A.7.1 NAME OF NURSE

10A.7.1.1 NURSE 1

10A.7.1.1.1 PHOTO OF NURSE

10A.7.1.1.2 DETAILS

10A.7.1.1.3 LIVE GPS COORDINATES

8 REFERS TO SENSOR FEED SECTION OF FIG. 8 IN THIS DOCUMENT

8 REFERS TO COMMUNICATION FEED SECTION OF FIG. 8 IN THIS DOCUMENT

8 REFERS TO VIDEO FEED SECTION OF FIG. 8 IN THIS DOCUMENT

8 REFERS TO VITALS FEED SECTION OF FIG. 8 IN THIS DOCUMENT

8 REFERS TO RECORDS SECTION OF FIG. 8 IN THIS DOCUMENT

10A.7.2 TREATMENT BY NURSE

10A.7.3 DATE OF TREATMENT

10A.7.4 RESULT OF TREATMENT

10A.7.4.1 TO 10A.7.4.3 AI

10A.7.4.4 FURTHER SCREENS TO SHOW AI

10A.8 DOCTOR RECORDS

10A.9 SURGERY RECORDS

10A.10 INSURANCE RECORDS

10A.11 LAB RECORDS

10A.12 TESTS RECORDS

Legend for FIG. 10B

10B.1 HOLOGRAM OF A DOCTOR

10B.2 ACTUAL PHOTO

10B.3 DETAILS

10B.4 LIVE GPS COORDINATES

8 REFERS TO COMMUNICATION FEED SECTION OF FIG. 8 IN THIS DOCUMENT

8 REFERS TO VIDEO FEED SECTION OF FIG. 8 IN THIS DOCUMENT

8 REFERS TO SENSOR FEED SECTION OF FIG. 8 IN THIS DOCUMENT

8 REFERS TO VITALS FEED SECTION OF FIG. 8 IN THIS DOCUMENT

8, 9 & 10 REFERS TO RECORDS SECTION OF FIGS. 8, 9 & 10 IN THIS DOCUMENT

10B.5 DUTY ROSTER

11 REFERS TO FIG. 11 IN THIS DOCUMENT

10B.6 SPECIALIZATIONS

10B.6.1 NEURO

12 REFERS TO FIG. 12 IN THIS DOCUMENT

10B.6.2 OPTHO

10B.6.3 SPINAL

10B.6.4 CARDIO

10B.6.5 ENDO

10B.6.6 DERMA

Legend for FIG. 11

10B REFERS TO DUTY ROSTER SECTION OF FIG. 10B IN THIS DOCUMENT

11.1 DAY

11.2 WEEK

11.3 MONTH

11.4 YEAR

11.5 HISTORICAL

11.6 CALENDAR OPENS

11.6.1 HOUR

11.6.2 TIME

11.6.3 DUTY SCHEDULE

11.6.3.1 OPENS TO FURTHER SCREENS

11.6.4 TASK COMPLETION

11.6.4.1 DIAGRAMS

11.6.4.2 GRAPHS

11.6.4.3 AI ANALYTICS

Legend for FIG. 12

10B REFERS TO SPECIALIZATIONS SECTION OF FIG. 10B IN THIS DOCUMENT

12.1 PATIENT CASES

12.2 SURGERIES

12.2.1 CLICK TO OPEN MORE SCREENS

12.3 SPECIALIZATIONS AREA 12.4 COMPLAINTS

Legend for FIG. 13

13.1 HOLOGRAM OF A NURSE

10, 11 & 12 REFERS TO FIGS. 10, 11 & 12 MODELLED FOR NURSE

Legend for FIG. 14

| | |
|---|---|
| 14.1 | HOLOGRAM OF AN AMBULANCE |
| 14.1.1 | MINI WIND TURBINES |
| 14.1.2 | SOLAR PANELS |
| 14.2 | ACTUAL PHOTO OF AMBULANCE |
| 14.3 | LIVE GPS COORDINATES |
| 14.4 | DETAILS |
| | 8 REFERS TO VIDEO FEED SECTION OF |
| | FIG. 8 IN THIS DOCUMENT |
| | 8 REFERS TO SENSOR FEED SECTION OF |
| | FIG. 8 IN THIS DOCUMENT |
| | 8 REFERS TO COMMUNICATION FEED |
| | SECTION OF FIG. 8 IN THIS |
| | DOCUMENT |
| 14.5 | AMBULANCE CREW |
| 14.5.1 TO 14.5.3 | REFERS TO CREW |
| | 10 REFERS TO FIG. 10 IN THIS |
| | DOCUMENT WHICH OPENS FOR EACH |
| | CREW |
| 14.6 | EQUIPMENT/INVENTORY |
| 14.6.1 TO 14.6.3 | REFERS TO |
| | EQUIPMENT'S |
| | 15 REFERS TO FIG. 15 IN THIS |
| | DOCUMENT |
| 14.7 | SELF DRIVING CONTROLS |
| | 16 REFERS TO FIG. 16 IN THIS |
| | DOCUMENT |
| 14.8 | POWER CONTROLS |
| | 17 REFERS TO FIG. 17 IN THIS |
| | DOCUMENT |
| 14.9 | AMBULANCE DIGITAL DISPLAYS |
| 14.9.1 | SPEED |
| 14.9.2 | DISTANCE |
| 14.9.3 | ESTIMATED TIME OF ARRIVAL |
| 14.9.4 | FIRST RESPONSE TIME |
| 14.10 | MANUALS |
| | 18 REFER TO FIG. 18 IN THIS |
| | DOCUMENT |
| 14.11 | MANUFACTURER |
| | 19 REFER TO FIG. 19 IN THIS |
| | DOCUMENT |
| 4.12 | ADVERTISER |
| | 11 REFER TO ROSTER SECTION OF |
| | FIG. 11 IN THIS DOCUMENT |

Legend for FIG. 15

14 REFER TO EQUIPMENT/INVENTORY SECTION OF FIG. 14 IN THIS DOCUMENT

15.1 ACTUAL PHOTO OF EQUIPMENT

15.2 DETAILS

15.3 LIVE GPS COORDINATES

8 REFERS TO SENSOR FEED SECTION OF FIG. 8 IN THIS DOCUMENT

19 REFER TO MANUFACTURER SECTION OF FIG. 19 IN THIS DOCUMENT

18 REFER TO MANUALS SECTION OF FIG. 18 IN THIS DOCUMENT

15.4 EQUIPMENT CONTROL BUTTONS

15.4.1 TO 15.4.10 ARE EQUIPMENT CONTROL BUTTONS FROM 1 TO 10

15.4.5.1 CLICK TO CONTROL OPERATION OF EQUIPMENT

8 REFERS TO VIDEO FEED SECTION OF FIG. 8 IN THIS DOCUMENT

15.5 EQUIPMENT PARTS

15.5.1 TO 15.5.4 ARE EQUIPMENT PARTS

15.5.4.1 HOLOGRAM OF A PART

15.5.4.2 ACTUAL PHOTO OF PART

15.5.4.3 DETAILS

8 REFERS TO SENSOR FEED SECTION OF FIG. 8 IN THIS DOCUMENT

19 REFER TO MANUFACTURER SECTION OF FIG. 19 IN THIS DOCUMENT

15.5.4.4 PART CONTROL BUTTONS

15.5.4.4.1 CLICK TO CONTROL OPERATION OF THAT PART

18 REFER TO MANUALS SECTION OF FIG. 18 IN THIS DOCUMENT

Legend for FIG. 16

14 REFER TO SELF DRIVING CONTROLS SECTION OF FIG. 14 IN THIS DOCUMENT

16.1 LIVE VIDEO FEED OF AI DRIVING

16.2 DIGITAL DISPLAYS

16.2.1 DISPLAYS

16.2.1.1 SPEED

16.2.1.2 FUEL

16.2.1.3 POWER

16.2.1.4 RPM

16.2.1.5 BRAKE FLUID

16.2.1.6 AIR PRESSURE

16.3 LOCATION MAP

16.4 LIVE VIDEO FEED

16.5 ESTIMATED TIME OF ARRIVAL

Legend for FIG. 17

14 REFER TO SELF POWER CONTROLS SECTION OF FIG. 14 IN THIS DOCUMENT

17.1 CURRENT POWER CONSUMPTION

17.1.1 OPENS SCREENS

17.2 HISTORICAL POWER CONSUMPTION

17.2.1 HISTORICAL RECORDS

17.2.1.1 DAY

17.2.1.2 WEEK

17.2.1.3 MONTH

17.2.1.4 YEAR

17.2.2 AI ANALYTICS

17.2.2.1 DAY

17.2.2.2 WEEK

17.2.2.3 MONTH

17.2.2.4 YEAR

17.3 CURRENT POWER STORAGE

17.3.1 SOLAR

17.3.1.1 SOLAR BATTERY AVAILABLE

17.3.1.1.1 GAUGES

17.3.2 WIND

17.3.2.1 WIND ENERGY

Legend for FIG. 18

14 REFER TO SELF MANUALS SECTION OF FIG. 14 IN THIS DOCUMENT

18.1 OPERATION MANUALS

18.1.1 DIGITAL SCANS OPEN

18.2 MATERIALS USED FOR CONSTRUCTION

18.2.1 DIGITAL SCANS OPEN

18.3 BLUEPRINTS

18.3.1 DIGITAL SCANS OPEN

18.4 MAINTENANCE

18.4.1 DIGITAL MAINTENANCE RECORDS

18.4.2 DIGITAL MAINTENANCE SCHEDULES

18.4.2.1

18.4.2.2

18.4.2.3

18.4.2.4

Legend for FIG. 19

14 REFER TO MANUFACTURER SECTION OF FIG. 14 IN THIS DOCUMENT

19.1 DETAILS OF MANUFACTURER

19.1.1 SCREENS WITH DETAILS OPEN

19.2 COMMUNICATION FEED TO MANUFACTURER

8 REFERS TO COMMUNICATION FEED SECTION OF FIG. 8 IN THIS DOCUMENT

Legend for FIG. 20

14 REFER TO ADVERTISER SECTION OF FIG. 14 IN THIS DOCUMENT

20.1 DETAILS OF ADVERTISER

20.1.1 SCREENS WITH DETAILS OPEN

20.2 COMMUNICATION FEED TO ADVERTISER

8 REFERS TO COMMUNICATION FEED SECTION OF FIG. 8 IN THIS DOCUMENT

20.3 HISTORICAL RECORDS

20.3.1 DIGITAL SCANS OF ALL ADVERTISER RECORDS

Legend for FIG. 21

21.1 HOSPITALS

21.1.1 WIND TURBINES

21.1.2 SOLAR PANELS

21.2 ACTUAL PHOTO OF HOSPITALS

21.3 LIVE GPS COORDINATES

21.4 DETAILS OF HOSPITALS

8 REFERS TO SENSOR FEED OF FIG. 8 OF THIS DOCUMENT

8 REFERS TO VIDEO FEED OF FIG. 8 OF THIS DOCUMENT

8 REFERS TO COMMUNICATION FEED OF FIG. 8 OF THIS DOCUMENT

21.5 REFERS AMBULANCE VEHICLES

1,2 & 3 REFERS TO NUMBER ALLOCATED TO VARIOUS AMBULANCE VEHICLES

14 REFERS TO FIG. 14 MAPPED FOR EACH VEHICLE

18 REFERS TO MANUALS SECTION OF FIG. 18 OF THIS DOCUMENT

19 REFERS TO MANUFACTURER SECTION OF FIG. 19 OF THIS DOCUMENT

20 REFERS TO ADVERTISER SECTION OF FIG. 20 OF THIS DOCUMENT

10 REFERS TO STAFF SECTION OF FIG. 10 OF THIS DOCUMENT

8 REFERS TO PATIENT SECTION OF FIG. 8 OF THIS DOCUMENT

21.6 UTILITY CONSUMPTION

21.6.1 WATER

21.6.2 GAS

21.6.3 ENERGY

21.6.4 GARBAGE

22 REFERS TO FIG. 22 OF THIS DOCUMENT

21.6.5 SEWAGE

21.6.6 MEDICAL WASTE

21.6.7 OXYGEN

21.6.8 LIGHTING

21.7 PARKING LOT

32 REFERS TO FIG. 32 OF THIS DOCUMENT

17 REFER TO POWER GENERATION FEED OF SECTION 17 FROM THIS DOCUMENT

21.8 3D MEDICAL PRINTER

31 REFERS TO FIG. 31 OF THIS DOCUMENT

21.9 DEPARTMENTS

21.9.1 TO 29.3 REFERS TO VARIOUS WARDS OF HOSPITALS

23 REFERS TO FIG. 23 OF THIS DOCUMENT

21.9.4 DEPARTMENTS

21.9.5 LABS

21.9.6 DIAGNOSTICS SENSORS

11 REFERS TO ROSTERS OF HOSPITAL OF FIG. 11 FROM THIS DOCUMENT

21.10 WASTE MANAGEMENT

24 REFERS TO FIG. 24 OF THIS DOCUMENT

21.11 EQUIPMENT′S/INVENTORY

15 REFERS TO FIG. 15 OF THIS DOCUMENT

21.12 PATIENT ASSISTANCE CENTRE

25 REFERS TO FIG. 25 OF THIS DOCUMENT

21.13 RECORDS

8,9 & 10 REFERS TO FIGS. 8,9 & 10 MAPPED FOR THIS SECTION

21.14 HOSPITAL ERP

21.14.1 LINKS TO ERP

21.15 BILLING ERP

21.16 FINANCIAL ERP

Legend for FIG. 22

22.1 NAME OF UTILITY

22.1.1 DAY CONSUMPTION

22.1.2 HOUR CONSUMPTION

22.1.3 WEEK CONSUMPTION

22.1.4 MONTH CONSUMPTION

22.1.4.1 DAY

22.1.4.2 QUANTITY

22.1.4.3 GRAPHS/DIAGRAMS

22.1.4.4 AI

22.1.4.4.1 OPENS “AI” BASED ANALYTICS SCREENS

22.1.4.5 DIAGRAMS/GRAPHS AND SCREENS

22.1.5 YEAR CONSUMPTION

22.1.6 DECADE CONSUMPTION

8 REFERS TO SENSOR SECTION OF FIG. 8 MODELLED FOR EACH UTILITY AS REQUIRED

22.2 UTILITY BILLS

22.2.1 MONTH

22.2.1.1 RECORD OPENS

22.2.2 YEAR

22.2.2.1 RECORD OPENS

22.2.3 DECADE

22.2.3.1 RECORD OPENS

22.3 UTILITY PROVIDER

8 REFERS FO COMMUNICATION FEED OF FIG. 8 FROM THIS DOCUMENT

22.3.1 DETAILS OF UTILITY PROVIDER SUCH AS NAME, ADDRESS ETC.

22.4 DETAILS OF UTILITY

22.4.1 TYPE

22.4.2 QUALITY

22.4.2.1 CHEMICAL COMPOSITION

22.4.2.1.1 OPENS SCREENS

22.4.2.2 SPECIFICATION OF UTILITY

Legend for FIG. 23

21 REFER TO DEPARTMENT SECTION OF FIG. 21 IN THIS DOCUMENT

23.1 ACTUAL PHOTO

23.2 GPS LOCATION

23.3 DETAILS

11 REFER TO ROSTERS SECTION OF FIG. 11 IN THIS DOCUMENT

10 REFER TO CREW/STAFF SECTION OF FIG. 10 IN THIS DOCUMENT

8 REFER TO VIDEO FEED SECTION OF FIG. 8 IN THIS DOCUMENT

8 REFER TO SENSOR FEED SECTION OF FIG. 8 IN THIS DOCUMENT

8 REFER TO COMMUNICATION FEED SECTION OF FIG. 8 IN THIS DOCUMENT

8 REFER TO PATIENTS SECTION OF FIG. 8 IN THIS DOCUMENT

18 REFER TO MANUALS SECTION OF FIG. 18 IN THIS DOCUMENT

23.4 HOSPITAL BED CONFIGURATION

23.4.1 TO 23.4.9 ARE HOSPITAL BEDS CONFIGURATION

8 REFER TO PATIENT SECTION OF FIG. 8 IN THIS DOCUMENT

8 REFER TO COMMUNICATION FEED SECTION OF FIG. 8 IN THIS DOCUMENT

8 REFER TO DOCTOR SECTION OF FIG. 8 IN THIS DOCUMENT

8 REFER TO VIDEO FEED SECTION OF FIG. 8 IN THIS DOCUMENT

18 REFER TO MANUALS SECTION OF FIG. 18 IN THIS DOCUMENT

8 REFER TO SENSOR FEED SECTION OF FIG. 8 IN THIS DOCUMENT

19 REFER TO MANUFACTURER SECTION OF FIG. 19 IN THIS DOCUMENT

11 REFER TO ROSTERS SECTION OF FIG. 11 IN THIS DOCUMENT

19 REFER TO MANUFACTURER SECTION OF FIG. 19 IN THIS DOCUMENT

26 REFER TO INVENTORY SECTION OF FIG. 26 IN THIS DOCUMENT

21 REFER TO UTILITY CONSUMPTION SECTION OF FIG. 21 IN THIS DOCUMENT

17 REFER TO POWER GENERATION FEED SECTION OF FIG. 17 IN THIS DOCUMENT

24 REFER TO WASTE MANAGEMENT SECTION OF FIG. 24 IN THIS DOCUMENT

8, 9 & 10 REFER TO RECORDS SECTION OF FIGS. 8, 9 & 10 IN THIS DOCUMENT

Legend for FIG. 24

21 REFER TO WASTE MANAGEMENT SECTION OF FIG. 21 IN THIS DOCUMENT

24.1 WASTE SEGREGATION

24.2 WASTE RECYCLING

24.3 WASTE DISPOSAL

24.4 WASTE ENERGY GENERATION

24.5 WASTE TRANSPORTATION

Legend for FIG. 25

21 REFER TO PATIENT ASSISTANCE CENTRE SECTION OF FIG. 21 IN THIS DOCUMENT

25.1 PATIENT BATHS

25.2 PATIENT FOOD

25.3 PATIENT MEDICATION

25.4 PATIENT TELEMEDICINE

25.5 INTRAVENOUS SERVICES

25.6 VENTILATOR SERVICES

25.7 OXYGEN SERVICES

25.7.1 OPENS TO FURTHER SCREENS

Legend for FIG. 26

26.1 HOLOGRAM OF A CLINIC

21 REFERS TO FIG. 21 MODELLED FOR A CLINIC

Legend for FIG. 27

27.1 HOLOGRAM OF A PHARMACY

28 REFERS TO FIG. 28 OF THIS DOCUMENT

24 REFERS TO FIG. 24 OF THIS DOCUMENT

27.2 PHARMACY ERP

27.2.1 LINKS TO PHARMACY ERP SYSTEMS

Legend for FIG. 28A

28A.1 HOLOGRAM OF A MEDICAL ROBOT

28A.2 ACTUAL PHOTO

28A.3 DETAILS

28A.4 LIVE GPS COORDINATES

8 REFER TO SENSOR FEED SECTION OF FIG. 8 IN THIS DOCUMENT

8 REFER TO VIDEO FEED SECTION OF FIG. 8 IN THIS DOCUMENT

19 REFER TO MANUFACTURER SECTION OF FIG. 19 IN THIS DOCUMENT

15 REFER TO EQUIPMENT′S/INVENTORY SECTION OF FIG. 15 IN THIS DOCUMENT

18 REFER TO MANUALS SECTION OF FIG. 18 IN THIS DOCUMENT

8 REFER TO COMMUNICATION FEED SECTION OF FIG. 8 IN THIS DOCUMENT

8, 9 & 10 REFER TO RECORDS SECTION OF FIGS. 8, 9 & 10 IN THIS DOCUMENT

17 REFER TO POWER GENERATION FEED SECTION OF FIG. 8 IN THIS DOCUMENT

22 REFER TO UTILITY CONSUMPTION SECTION OF FIG. 22 IN THIS DOCUMENT

10 REFER TO STAFF/CREW SECTION OF FIG. 18 IN THIS DOCUMENT

15 REFER TO ROBOT OPERATIONS CONTROL BUTTONS SECTION OF FIG. 15 IN THIS DOCUMENT

11 REFER TO ROSTERS SECTION OF FIG. 11 IN THIS DOCUMENT

28A.5 AI AUTONOMOUS

28A.5.1 LIVE FEED

28A.5.2 LIVE RECORDING

28A.5.3 DIGITAL DISPLAYS

Legend for FIG. 28B

28B.1 HOLOGRAM OF A MEDICAL DRONE

14 REFERS TO FIG. 14 IN THIS DOCUMENT

28B.2 LOAD CAPACITY

28B.2.1 DISPLAYS

28B.3 LOADING CHAMBER

28B.3.1 OPENS FURTHER SCREENS

28B.4 LOADING CHAMBER REFRIGERATOR

28B.4.1 OPENS FURTHER SCREENS

Legend for FIG. 29

29.1 HOLOGRAM OF A MEDICAL 3-D PRINTER

28 REFERS TO FIG. 28 IN THIS DOCUMENT

29.2 PRINTING SELECTIONS

29.2.1 HUMAN TISSUE PRINTING

29.2.2 HUMAN BONE PRINTING

29.2.3 PROSTHETICS PRINTING

29.2.4 DRUG PRINTING

29.2.5 DNA PRINTING

29.2.6 BLOOD PRINTING

29.2.7 TO 29.2.12 ARE DESIGN SELECTIONS

29.2.13 TO 29.2.18 ARE MATERIAL SELECTIONS

29.2.13.1 TO OPEN FURTHER SCREENS

29.2.19 TO 29.2.24 ARE PRINTS

29.2.19.1 PRINT DISPLAYS

29.2.19.2 VIDEO FEED

29.2.19.3 PRINTING ANALYTICS

Legend for FIG. 30

30.1 HOLOGRAM OF A PARKING

30.1.1 PARKING LEVEL 1

30.1.2 PARKING LEVEL 2

30.1.3 PARKING LEVEL 3

30.2 ACTUAL PHOTO

30.3 LIVE GPS COORDINATES

8 REFER TO VIDEO FEED SECTION OF FIG. 8 IN THIS DOCUMENT

8 REFER TO COMMUNICATION FEED SECTION OF FIG. 8 IN THIS DOCUMENT

8 REFER TO SENSOR FEED SECTION OF FIG. 8 IN THIS DOCUMENT

19 REFER TO MANUFACTURER SECTION OF FIG. 19 IN THIS DOCUMENT

18 REFER TO MANUALS SECTION OF FIG. 18 IN THIS DOCUMENT

17 REFER TO POWER GENERATION FEED SECTION OF FIG. 17 IN THIS DOCUMENT

10 REFER TO STAFF/CREW SECTION OF FIG. 10 IN THIS DOCUMENT

30.4 PARKING SPACES/LEVELS

30.4.1 TO 30.4.6 ARE NO PARKING SPACES/LEVELS

30.4.1.1 TO 30.4.1.4 ARE VEHICLES IN EACH PARKING LEVEL

14 REFERS TO FIG. 14 IN THIS DOCUMENT

30.4.1.2.1 CURRENT PARKING TIME

30.4.1.2.1.1 DIGITAL CLOCK

30.4.1.2.2 CURRENT PARKING CHARGES

30.4.1.2.2.1 DIGITAL CLOCK

15 REFERS TO FIG. 15 IN THIS DOCUMENT

30.5 PARKING LOT ERP

30.5.1 LINK TO ERP SYSTEMS

Legend for FIG. 31

31.1 ZEUS CENTRAL COMMAND

31.2 ZEUS AI

31.3 DESCRIPTIVE ANALYTICS AND OPERATIONS

31.3.1 SCREENS OPEN FOR EACH PARAMETER WITH ALL KINDS OF ANALYTICS, PLANNING, OPERATIONS

31.3.2 FOR ALL POSSIBLE AND REQUIRED PARAMETERS

31.4 PREDICTIVE ANALYTICS AND OPERATIONS

31.4.1 SCREENS OPEN FOR EACH PARAMETER WITH ALL KINDS OF ANALYTICS, PLANNING OPERATIONS

31.4.2 FOR ALL POSSIBLE AND REQUIRED PARAMETERS

31.5 PRESCRIPTIVE ANALYTICS AND OPERATIONS

31.5.1 SCREENS OPEN FOR EACH PARAMETER WITH ALL KINDS OF ANALYTICS, PLANNING OPERATIONS

31.5.2 FOR ALL POSSIBLE AND REQUIRED PARAMETERS

31.6 AI COGNITIVE ANALYTICS OPERATIONS (WARNING: AUTONOMY GIVEN TO AI)

31.6.1 SCREENS OPEN FOR SELECTED PARAMETERS

Legend for FIG. 32

FIG. 32.1 HOLOGRAM OF ROTATING EARTH

FIGS. 32.2 TO 32.3 REPRESENTS HOLOGRAM OF ALL ASSETS WHICH CAN BE CLICKED TO OPEN THEIR SCREENS

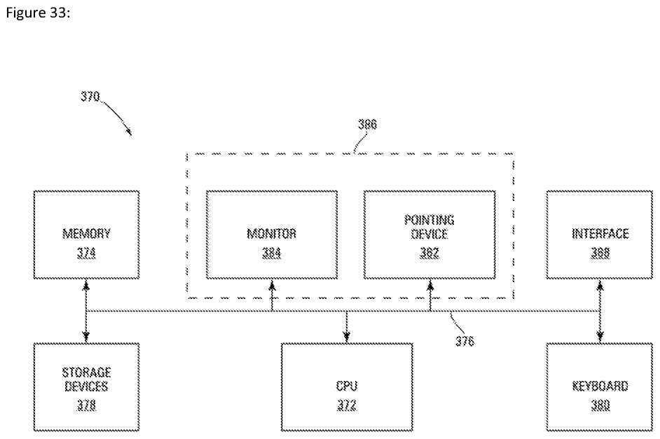

FIG. 33 and the related discussion provide a brief, general description of a suitable computing environment in which embodiments of the present disclosure can be implemented. Although not required, components of the system can be implemented at least in part, in the general context of computer-executable instructions, such as program modules, being executed by a computer 370 which may be connected in wired or wireless fashion to smart eyewear (e.g., VR glasses and/or projectors). Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the invention may be practiced with other computer system configurations, including multi-processor systems, networked personal computers, mini computers, main frame computers, smart screens, mobile devices (e.g., smart phones, tablets) and the like. Aspects of the invention may also be practiced in distributed computing environments where tasks are performed by remote processing devices that are linked through a communications network. In a distributed computer environment, program modules may be located in both local and remote memory storage devices.

The computer 370 comprises a conventional computer having a central processing unit (CPU) 372, memory 374 and a system bus 376, which couples various system components, including memory 374 to the CPU 372. The system bus 376 may be any of several types of bus structures including a memory bus or a memory controller, a peripheral bus, and a local bus using any of a variety of bus architectures. The memory 374 includes read only memory (ROM) and random access memory (RAM). A basic input/output (BIOS) containing the basic routine that helps to transfer information between elements within the computer 370, such as during start-up, is stored in ROM. Storage devices 378, such as a hard disk, a floppy disk drive, an optical disk drive, etc., are coupled to the system bus 376 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 374 from at least one of the storage devices 378 with or without accompanying data.

Input devices such as a keyboard 380 and/or pointing device (e.g. mouse, joystick(s)) 382, or the like, allow the user to provide commands to the computer 370. A monitor 384 or other type of output device can be further connected to the system bus 376 via a suitable interface and can provide feedback to the user. If the monitor 384 is a touch screen, the pointing device 382 can be incorporated therewith. The monitor 384 and input pointing device 382 such as mouse together with corresponding software drivers can form a graphical user interface (GUI) 386 for computer 370. Interfaces 388 on the system controller 300 allow communication to other computer systems if necessary. Interfaces 388 also represent circuitry used to send signals to or receive signals from the actuators and/or sensing devices mentioned above. Commonly, such circuitry comprises digital-to-analog (D/A) and analog-to-digital (A/D) converters as is well known in the art.

Although the present invention has been described with reference to preferred embodiments, workers skilled in the art will recognize that changes may be made in form and detail without departing from the spirit and scope of the invention.

We claim:

1. A system for providing complete global mobility, operation and execution anytime, anywhere, anyplace and by any user, the system comprising:
a computing device with a display device, memory, at least one processor, and machine-readable instructions executable with the at least one processor, the computing device configured to generate a live hologram display of available physical assets complete with monitoring, visualization, communication, operations and execution capabilities, the hologram projections generated using augmented reality-mixed reality, wherein the hologram display is data-infused with autonomous artificial intelligence-powered descriptive, predictive, prescriptive and cognitive analytics and operative capabilities for global healthcare ecosystems, and wherein each hologram of the physical assets in the hologram display having one or more data points.

2. The system as claimed in claim 1 wherein the live hologram display provides live holographic visualizations of medical assets and a geographic space, the live visualizations in holographic visualizations being provided with artificial intelligence analytics in real time, thereby leading to total awareness, planning, rehearsal, and execution-operations.

3. The system as claimed in claim 1 wherein the system creates absolute situational awareness by providing real-time information on current situation and execution-operational capabilities, and is capable of being accessed anytime, anywhere and provides complete mobility for entire operations.

4. The system as claimed in claim 1 wherein the computing device is operated by touch and voice command and wherein the display device generates a display in augmented reality-mixed reality holographic screens or projections.

5. The system as claimed in claim 4, wherein the augmented reality-mixed reality holographic screens and projections comprise a smart eyewear device that can be worn by a user, said smart eyewear device being activated by voice command and having a plurality of clickable buttons for operation.

6. The system as claimed in claim 1 wherein the system is configured as a secured-encrypted environment.

7. The system as claimed in claim 1, wherein an authority level of access per screen and function is decided by the computing device pursuant to a user specification and wherein at least one hologram of the live hologram display is either hand-held or capable of being moved around.

8. The system as claimed in claim 1 wherein the system provides a single global platform for healthcare, pharma, medical emergency, medical waste, medical manufacturing, medical robotics-UAV, medical facilities, patient and medical staff command and control, operations and planning.

9. The system as claimed in claim 1, wherein the available physical assets comprise one or more asset selected from the group consisting of hospitals, patients, ambulances, medical drones, pharmacy, medical waste deposit units, clinics, doctors, medical manufacturers, nurses, medical robots, medical waste deposit units, and combinations thereof.

10. The system as claimed in claim 1 wherein the system includes an interface comprises options of patient management, hospital management, pharmacy management, ambulance/emergency management, medical waste disposal management, medical manufacturing management, medical drones management, medical doctors and nurses management, medical robotics management, and corresponding artificial intelligence (AI) management comprising patient AI, hospital AI, pharmacy AI, ambulance/emergency AI, medical waste disposal AI, medical manufacturing AI, medical drones AI, medical doctors and nurses AI and medical robotics AI.

11. The system as claimed in claim 1 wherein the live hologram display provides a hologram map of a single country or a combination of two or more countries such that the hologram map of any single country or a combination of two or more countries is divided into micro-GPS grids.

12. The system as claimed in claim 1 wherein the live hologram display provides a satellite image of one of the available physical assets or a combination of two or more of the available physical assets and also provides an air view or a ground view of an asset or a combination of two or more of the available physical assets.

13. The system as claimed in claim 1 wherein the live hologram display provides actual photo, live GPS coordinates, vitals feed, records, communication feed, video feed, sensor feed, duty roaster, specialization, wind turbines, solar panels, ambulance crew, equipment/inventory, self-driving control, power controls, digital displays, manuals, manufacturer, advertiser, equipment control, parts, live video feed, location map, estimated time of arrival, current power consumption, historical power consumption, current power storage, material, blueprints, maintenance, ambulance vehicles, utility consumption, parking, 3D medical printer, departments, waste management, patient assistance center, hotel ERP, billing ERP, financial ERP, names, bills, utility provider, hospital bed configuration, waste segregation, waste recycling, waste disposal, waste energy generation, waste transportation, patient baths, patient food, patient medication, patient telemedicine, intravenous services, ventilator services, oxygen services, pharmacy ERP, AI autonomous, load capacity, load chamber, loading chamber refrigeration, printing selections, parking lot ERP, central command and screens of AI, descriptive analytics and operations, predictive analytics and operations, prescriptive analytics and operations, AI cognitive analytics, of one or more of the available physical assets.

14. A method for providing complete global mobility, operation and execution anytime, anywhere, anyplace and by any user, the method comprising:
incorporating data infused holograms with autonomous artificial intelligence (Ai) powered descriptive, predictive, prescriptive and cognitive analytics and operative capabilities for global healthcare Ecosystems; and
creating live hologram projections of all available physical assets complete with monitoring, visualization, communication, operations and execution capabilities using augmented reality-mixed reality, each live hologram projection of the available physical assets having one or more data points.

15. The method as claimed in claim 14, being operated by clickable buttons and/or voice command and further comprising providing live holographic visualizations of all medical assets and earth surfaces including seas, waterways and land.

16. A method for executing a system for providing complete global mobility, operation and execution anytime, anywhere, anyplace and by any user, the method comprising:
starting a device with augmented reality-mixed reality holographic projection capability;
selecting a management option;
selecting a country or a combination of two or more countries to obtain a hologram map with micro GPS grids of the selected country or a combination of two or more countries;
obtaining an appropriate image; and
obtaining a hologram with details and vitals of a medical asset or a combination of two or more medical assets.

17. The method as claimed in claim 16, wherein the management option comprises options of patient management, hospital management, pharmacy management, ambulance/emergency management, medical waste disposal management, medical manufacturing management, medical drones management, medical doctors and nurses management, medical robotics management, patient AI, hospital AI, pharmacy AI, ambulance/emergency AI, medical waste disposal AI, medical manufacturing AI, medical drones AI, medical doctors and nurses AI, medical robotics AI.

18. The method as claimed in claim 16, wherein the step of obtaining an appropriate image comprises obtaining a satellite image in air view or a ground view of a medical asset or a combination of two or more medical assets.

19. The method as claimed in claim 16, the device being operated by clickable buttons and/or voice command and the method further comprising the step of obtaining details of a manual and/or a manufacturer identification and/or an advertiser of the device.
